(19) United States
(12) Patent Application Publication
(10) Pub. No.: US 2011/0236980 A1
(43) Pub. Date: Sep. 29, 2011

(54) Automated Synthesis or Sequencing Apparatus and Method for Making and Using Same

(75) Inventor: Michael A. Rea, Sugarland, TX (US)

(73) Assignee: LIFE TECHNOLOGIES CORPORATION, Carlsbad, CA (US)

(21) Appl. No.: 12/985,489

(22) Filed: Jan. 6, 2011

Related U.S. Application Data
(63) Continuation of application No. 11/781,157, filed on Jul. 20, 2007, now abandoned.
(60) Provisional application No. 60/832,010, filed on Jul. 20, 2006.

(30) Foreign Application Priority Data
Jul. 20, 2007 (US) PCT/US2008/008614

(51) Int. Cl. G01N 35/02

(52) U.S. Cl. 436/47

(57) ABSTRACT

An apparatus and method based on the apparatus is disclosed for automated single molecule or molecular assemblage detection via light irradiation and detection of transient FRET between a donor or acceptor bound to an immobilized single molecule or molecular assemblage and a corresponding acceptor or donor associated with, covalently bonded to, a reagent, where the donor or acceptor associated with the reagent is transiently in FRET proximity to the acceptor or donor associated with the immobilized molecule or molecular assemblage.

### RELATED APPLICATIONS

This application claims provisional priority to U.S. Provisional Patent Application No. 60/832,010 filed Jul. 20, 2006 (20 Jul. 2006).

### BACKGROUND OF THE INVENTION

1. Field of the Invention

The present invention relates to an automated single molecule detection apparatus and method for making and using the apparatus.

More particularly, the present invention relates to an automated single molecule detection apparatus and method for making and using the apparatus, where the apparatus includes: (1) a continuous substrate including zones having one binding agent or a plurality of binding agents; (2) one component station or a plurality of component stations adapted to introduce one component or a plurality of components onto and/or into the zones, where the molecule or one or more of the components of the molecular complexes or assemblages interact with or bond to the binding agents to form pre-reactive sites within the zones and where the molecule, a component of the molecular complexes or assemblages, the binding agents and/or the substrate include a detectable agent such as a tag, label, or moiety, having a detectable property and where the molecules, complexes or assemblages are sparsely distributed to form sites that are independently detectable; (3) a mapping station adapted to locate or map detectable pre-reactive sites within a viewing field of the mapping unit, where the viewing field comprises the entire zone or portion thereof; (4) an initiation station adapted to introduce one initiator or a plurality of initiator onto and/or into zones to convert one, some or all of the located or mapped detectable pre-reactive sites into corresponding reactive single sites; (5) a detection station or a plurality of second detection stations adapted to monitor reaction events occurring at one, some or all of the reactive single sites corresponding to the mapped or located pre-reaction single sites within registered viewing field, again where the viewing field comprises the entire zone or a portion thereof; and (6) an analyzer adapted to receive signals from the mapping and detection stations and to convert the signals into output data corresponding to the detected events associated with one, some or all of the located reactive single molecular sites within the zones. Alternatively, the zones can include a pre-bound component or detectable agent.

2. Description of the Related Art

At present, nucleotide sequencing, oligonucleotide synthesis, peptide analysis, peptide synthesis, polysaccharide analysis, polysaccharide synthesis, mixed biomolecule analysis and synthesis are preformed at the multi-molecule level using large or macroscope ensembles—generally synthetical chemical approaches.

Recently, however, there has been considerable emphasis placed on detection of chemical reactions occurring one, a small ensemble or a large ensemble of reactive and/or interactive molecular sites and/or single reactive molecular sites, single molecule analysis, and single molecule synthesis. As the detection protocols and procedures for single molecule detection and the data analysis become robust, new technologies will need to be developed to efficiently and effectively exploit this fast growing world of small molecule ensemble or single molecule detection systems include the detection of systems where during the reaction a group on one reagent interacts in a detectable manner with a group on another reagent involved in the reaction.

Thus, there is a need in the art for an apparatus that is tailored to the detection of single molecules, molecular assemblages or molecular complexes, while minimizing the every present problem of contaminant introduction and detector interference from such contaminants and improving signal recognition and noise reduction and filtering.

### SUMMARY OF THE INVENTION

The present invention provides an apparatus for analyzing small, medium or large ensembles of reactive atomic or molecular sites or a single reactive atomic or molecular site in a continuous reaction/detection mode, an intermittent reaction/detection mode, a periodic reaction/detection mode, a semi-periodic reaction/detection mode, or a mixed mode format (a mixture of one or more of the other modes in any combination or permutation), where each reaction site includes a detectable agent that produces a detectable signal evidencing one or a series of atomic or molecular interactions and/or reactions.

### General

The present invention also provides an apparatus for analyzing small, medium or large ensembles of reactive atomic or molecular sites or a single reactive atomic or molecular site in a continuous reaction mode, an intermittent reaction mode, a periodic reaction mode, a semi-periodic reaction mode, or a mixed mode format (a mixture of one or more of the other modes in any combination or permutation). The apparatus includes a continuous substrate including zones formed therein and/or thereon. Each zone includes one binding agent or a plurality of binding agents. The apparatus also includes one or a plurality of component stations adapted to introduce one or a plurality of components onto and/or into the zones. One or more of the components are adapted to interact or bond to the binding agents to form bound or immobilized atomic systems, molecules, molecular complexes or molecular assemblages, where the binding agents, the atomic system, the molecule or one of the components of the complexes or assemblages and/or the substrate include a detectable agent such as a tag, label, or moiety, having a detectable agent. The apparatus may also include a mapping station adapted to locate or map distinct and detectable reactive sites within a viewing field comprising the entire zone or a portion thereof. The mapping station can include the same components as the detection stations and generally is a detection station, but it can be simplified because it is only looking at detectable agent that is associated with each site to that the site can be located or mapped. In certain applications, these agent is a donor and the mapping is designed to locate sites, preferably single sites, with an active donor.

In certain embodiments, the first detection or mapping station locates single sites—the first detection or mapping station determines a number and a location (maps) distinct and detectable species based on a detection grid superimposed on the viewing field of the detector or the detection or mapping station, where the viewing field comprises the entire zone or a portion thereof. The apparatus also includes an initiation station adapted to introduce one or a plurality of initiators onto and/or into the zones and a second detection station adapted to monitor reaction events occurring at one, some or all of the mapped sites within the viewing field, where the reaction events are evidenced by a change in the detectable property of the detectable agent associated with the site, by a change in the detectable property of the detectable agent associated with the initiators (tagged or labeled nucleotides in the case of nucleic acid sequencing), by an interaction between the detectable agent associated with the site and the detectable agent associated with the initiator, or by subsequent conversion of the agent on the initiator to a detectable agent after reaction. Again, in certain embodiments, the reactive sites comprise single reactive molecular sites, inside the zones. Finally, the apparatus includes an analyzer adapted to receive signals from the mapping and detection stations and to convert the signals into output data corresponding to the detected events that occur within the viewing field. The apparatus may also include a third detection station immediately following the second detection station and adapted to continue the detection of events associated with one, some or all of the mapped sites withing the viewing field. If the apparatus does not include a first detection station, a mapping station, then the reaction is simply initiated, mapped and monitored in a single step; otherwise, the single sites are first mapped so that reaction event monitoring can be facilitated. Alternatively, the zones of the substrate can include pre-bound or immobilized reagents, where the reagents can be binding sites, markers, donors such as quantum dots, or a component of the atomic or molecular site. In yet another alternative, the zones actually comprise cavities, channels and/or other confining structures in which the atomic system, molecule, molecular complex or molecular assemblage is confined.

### Substrates

General

The apparatuses of the invention are designed to utilized a continuous, semi-continuous or discontinuous substrate including zones having disposed therein and/or thereon one or a plurality of bound reagents, where the reagents can be binding sites, markers, donors such as quantum dots, or a component of the atomic or molecular site. The zones can be continuous or discrete. The zones can be spaced apart along a length or along a length and width of the substrate. The terms continuous means that the substrate extends laterally such as a tape made of a polymeric film, an extended length of a ceramic substrate, or a similar extended material onto which a zone or zones can be formed. In most embodiments, the zone or zones include binding agents or sites capable of binding and immobilizing one or a plurality of components that will make up an active site, where the binding sites are sparsely distributed within the zone or zones. The distribution can be either random or patterned. The distribution is formed in such a way that one, some or all of the resulting active sites are detectably distinct one from the other. The distributions are designed so that a majority of the binding sites will support only a single active site, atomic system, molecule, complex or assemblage, which is detectably distinct from all other active sites. The substrate can include one or a plurality of continuous zones that extend the length or width of the substrate. The substrate can include zones patterned on the substrate or randomly distributed on the substrate.

Films

The substrate can be a film. The film can be polymeric, ceramic or metallic with zones being transparent, semi-transparent or opaque to the wavelength of light used for excitation and/or detection.

Rigid Linear Substrate

The substrate can be a rigid linear substrate on which the zones are formed. The rigid substrate can include recessed areas in which the zones are formed or disposed. The substrate can be any rigid material with zones being transparent to the wavelength of light used for excitation and/or detection.

Rigid Disk Substrate

The substrate can be in the shape of a disk, with the zones either spiraling out from its center or in the form of concentric rings. The apparatus can include stations disposed on armatures that permit the stations to move linearly outward as the disk is rotated much as an out phonograph operated or inward.

The substrates are designed to be used with any single molecule detection format. For certain detection formats, the substrate must be transparent to light in a desired wavelength range. The zones can be signed to operate in a TIRF mode, a ZMW detection mode or other time of detection modes that require specialized substrate and zones formed within the substrate.

### Methods

General

The present invention also provides a method for analyzing one reaction site, a small ensemble of reaction sites, a medium ensemble of reaction sites and a large ensemble of reaction sites in a continuous reaction mode, an intermittent reaction mode, a periodic reaction mode, semi-periodic reaction mode, or a mixed mode format (a mixture of one or more of the other modes in any combination or permutation). The method includes the step of providing a substrate including zones having disposed therein and/or thereon one bound components or a plurality of sparsely distributed bound components, where the components are bound to corresponding sparsely distributed binding agents. One or more zones are then moved so that they are aligned with one or a plurality of component introduction or delivery stations adapted to introduce one or a plurality of reaction components onto and/or into the zones to form one or a sparse plurality of pre-reactive sites. Next, the zones are moved into alignment with a mapping station adapted to locate or map pre-reactive single molecular sites within or inside a viewing field of the zones relative to a grid to register detectable sites and to provide calibration data. Once the zone(s) has/have been mapped at the mapping station, the zone(s) is/are moved into alignment with an initiation station adapted to introduce one or a plurality of initiator onto and/or into the zone(s), where the bound component, the added components and the initiator combine to form active sites. Once the active sites are formed, the zone(s) is/are move into alignment with a detection station adapted to detect and/or monitor reaction events occurring at one, some or all of the located or mapped sites within or inside the viewing field of the detector, where again the viewing field can comprise the entire zone or a portion thereof. The mapping station and the detection station are in electronic or electrical communication (via wires or cables or wireless protocols) with an analyzer adapted to receive signals from the mapping and detecting stations and to convert the signals into output data corresponding to the detected events inside the zones.

Film Based

The present invention also provides a method for analyzing an ensemble of reactive sites or a single reactive site in a continuous reaction mode, an intermittent reaction mode, a periodic reaction mode, semi-periodic reaction mode, or a mixed mode format (a mixture of one or more of the other modes in any combination or permutation). The term ensemble means a collection of atomic systems (system where the activity is localized to one or a collections of atoms in the system such as a catalyst), molecules, molecular complexes or molecular assemblages numbering from about 1 to about 100,000 or more within a viewing field of a detection system. In certain embodiments, the ensemble numbers between about 1 to about 10,000 molecules, molecular complexes or molecular assemblages within a viewing field of the detection system. In certain embodiments, the ensemble numbers between about 1 to about 1,000 molecules, molecular complexes or molecular assemblages within a viewing field of the detection system. In certain embodiments, the ensemble numbers between about 1 to about 500 molecules, molecular complexes or molecular assemblages within a viewing field of the detection system. In certain embodiments, the ensemble numbers between about 1 to about 100 molecules, molecular complexes or molecular assemblages within a viewing field of the detection system. The method includes the step of providing a continuous film substrate including zones having disposed therein one or a plurality of bound components bound to respective binding agents, where the bound components, binding agents or the zone include a detectable agent such as a tag, label, group or moiety having a detectable property. The zone(s) is/are then move into alignment with one or a plurality of component introduction stations adapted to introduce one or a plurality of components onto and/or into the zones to form pre-reactive sites. Next, the zone/s is/are moved into alignment with a mapping station adapted to locate or map single pre-reactive sites within or inside the zones relative to a grid for calibration and site registration. Once the zones have been mapped at the first detection station, the zone/s is/are moved into alignment with an initiation station adapted to introduce one or a plurality of initiator onto and/or into the zones, where the bound component, the added components and the initiators combine to form reactive sites. Once the reactive sites are formed, the zone are moved into alignment with a second detection station adapted to monitor reaction events occurring at one, some or all of the located single reactive molecular sites within or inside the zones. Finally, data signals from the detection stations are forwarded and transferred to an analyzer station, where the signals are converted into output data corresponding to the detected events inside the zones.

Linear Rigid Substrate Based

The present invention also provides a method for analyzing ensembles of reactive molecular sites or a single reactive molecular site in a continuous reaction mode, an intermittent reaction mode, a periodic reaction mode, semi-periodic reaction mode, or a mixed mode format (a mixture of one or more of the other modes in any combination or permutation). The method includes the step of providing a rigid substrate including zones having disposed therein one or a plurality of bound reagents bound to respective binding agents, where the bound reagents, binding agents or the zone include a detectable tag, label, molecule or moiety. The zones are then moved into alignment with one or a plurality of component introduction stations adapted to introduce one or a plurality of components onto and/or into the zones to form pre-reactive molecular sites. Next, the zones are moved into alignment with a mapping station adapted to locate or map single reactive molecular sites within or inside the zones relative to a grid for calibration and site registration. Once the zones have been mapped at the mapping station, the zones are moved into alignment with an initiation station adapted to introduce one or a plurality of initiators onto and/or into the zones, where the bound reagents, the reaction reagents and the initiation reagents combine to form reactive sites. Once the reactive sites are formed, the zones are moved into alignment with a detecting station adapted to detect and/or monitor reaction events occurring at one, some or all of the located single reactive molecular sites within or inside the zones. Finally, data signals from the mapping and detecting stations are forwarded or transferred to an analyzer station, where the signals are converted into output data corresponding to the detected events inside the zones.

Disk Based

The present invention also provides a method for analyzing small ensembles of reactive molecular sites or single reactive molecular sites in a continuous reaction mode, an intermittent reaction mode, a periodic reaction mode, semi-periodic reaction mode, or a mixed mode format (a mixture of one or more of the other modes in any combination or permutation). The method includes the step of providing a continuous disk substrate including zones having disposed therein or thereon one or a plurality of bound reagents bound to one or a plurality of corresponding binding agents in the zones. The zones are then aligned with one reagent station or a plurality of reagent station, where one or a plurality of reaction reagents are introduced onto and/or into the zones. This process in repeated until all necessary reaction reagents have been introduced. Next, the zones are moved into alignment with a mapping station adapted to locate or map reactive molecular sites within or inside the zones relative to a grid adapted to calibrate and/or register active pre-reactive molecular complexes. Once the zones have been mapped, the zones are moved into alignment with an initiation station adapted to introduce one or a plurality of initiation reagents onto and/or into the zones, where the bound reagents, the reaction reagents and the initiation reagents combine to form reactive sites. Once the reactive sites are formed, the zone are then moved into alignment with a detecting station adapted to monitor reaction events occurring at one, some or all of the mapped or located single reactive molecular sites within or inside the zones. Finally, data signals from the mapping and detecting stations are forwarded to an analyzer station, where the signals are converted into output data corresponding to the detected events inside the zones.

### Definitions Used in the Invention

The term “distinct and detectable active site” means an atomic site or structure, a molecule, a molecular complex, or a molecular assemblage capable of undergoing one, many, a series or a sequence of biochemical, chemical and/or physical reactions and/or interactions, and capable of being detected before, during and/or after such reactions and/or interactions. In certain embodiments, molecular complexes and molecular assemblages includes those capable of forming nucleic acid sequences, peptide sequences, saccharide sequences, mixed sequences (nucleic acid-peptide sequences, peptide-saccharide sequences, nucleic acid-saccharide sequences, etc.) or other step-by-step polymerization reaction. In other embodiments, the assemblages are atomic sites comprising active catalytic sites.

The term “distinct and detectable single active site” means an individual atomic site or structure, a molecule, a molecular complex, or a molecular assemblage capable of undergoing one, many, a series or a sequence of biochemical, chemical and/or physical reactions and/or interactions, or to undergo a cyclical biochemical, chemical or physical reaction and/or interaction, and capable of being individually detected before, during and/or after a reaction and/or interaction without interference from other single active site. Such single molecular assemblages are well separated from other molecular assemblages permitting detection and analysis of signals of events (the cyclic reaction) occurring uniquely at that molecular assembly. In certain embodiments, molecular assemblages includes molecular assemblages capable of forming nucleic acid sequences, peptide sequences, saccharide sequences, mixed sequences (nucleic acid-peptide sequences, peptide-saccharide sequences, nucleic acid-saccharide sequences, etc.) or other step-by-step polymerization reaction.

The “bonded to” means that chemical and/or physical interactions sufficient to maintain the polymerase within a given region of the substrate under normal polymerizing conditions. The chemical and/or physical interactions include, without limitation, covalent bonding, ionic bonding, hydrogen bonding, apolar bonding, attractive electrostatic interactions, dipole interactions, or any other electrical or quantum mechanical interaction sufficient in tato to maintain the polymerase in its desired region.

The term “monomer” as used herein means any compound that can be incorporated into a growing molecular chain by a given polymerase. Such monomers include, without limitations, naturally occurring nucleotides (e.g., ATP, GTP, TTP, UTP, CTP, dATP, dGTP, dTTP, dUTP, dCTP, synthetic analogs), precursors for each nucleotide, non-naturally occurring nucleotides and their precursors or any other molecule that can be incorporated into a growing polymer chain by a given polymerase. Additionally, amino acids (natural or synthetic) for protein or protein analog synthesis, mono sacchamides for carbohydrate synthesis or other monomeric syntheses.

The term “polymerizing agents” means any agent capable of polymerizing monomers in a step-wise fashion or in a step-wise fashion relative to a specific template such as a DNA or RNA polymerase, reverse transcriptase, or the like, ribosomes, carbohydrate synthesizing enzymes or enzyme system, or other enzymes systems that polymerize monomers in a step-wise fashion.

The term “polymerase” as used herein means any molecule or molecular assemblage that can polymerize a set of monomers into a polymer having a predetermined sequence of the monomers, including, without limitation, naturally occurring polymerases or reverse transcriptases, mutated naturally occurring polymerases or reverse transcriptases, where the mutation involves the replacement of one or more or many amino acids with other amino acids, the insertion or deletion of one or more or many amino acids from the polymerases or reverse transcriptases, or the conjugation of parts of one or more polymerases or reverse transcriptases, non-naturally occurring polymerases or reverse transcriptases. The term polymerase also embraces synthetic molecules or molecular assemblage that can polymerize a polymer having a pre-determined sequence of monomers, or any other molecule or molecular assemblage that may have additional sequences that facilitate purification and/or immobilization and/or molecular interaction of the tags, and that can polymerize a polymer having a pre-determined or specified or templated sequence of monomers.

The term “atomic system or structure” means a system or structure including an active atomic site such as an active catalytic site.

The term “molecule” means a single molecular species.

The term “molecular complex” means a molecular structure comprising two molecules, which are associated with or non-covalently bonded to one another.

The term “molecular assemblage” means a molecular structure comprising three or more molecules, which are associated with or non-covalently bonded.

The term “reaction and/or interaction” means any chemical event that results in the formation or destruction of one or more chemical bonds or a physical event that results in a change in one or more properties of a molecule, molecular complex or molecular assemblage. The term reaction includes actual chemical reaction, binding interactions that result in a temporary associated complex, transient complexes, proximal association or any other type of chemical and/or physical interaction that give rise to a change in a detectable property of the interacting or reacting molecular, atomic, ionic, molecular complexes (comprising neutral and/or charged molecules), and/or molecular assemblages (comprising neutral and/or charged molecules).

The term “variant” means any genetically modified enzyme, where the mutation is designed to augment the reactivity, activity, processivity, binding efficiency, release efficiency, or any other aspect of an enzymes chemical behavior.

### BRIEF DESCRIPTION OF THE DRAWINGS

The invention can be better understood with reference to the following detailed description together with the appended illustrative drawings in which like elements are numbered the same.

FIG. 1A depicts a block diagram of a embodiment of a film based apparatus of this invention.

FIG. 1B depicts a block diagram of another embodiment of a film based apparatus of this invention.

FIG. 1C depicts a block diagram of another embodiment of a film based apparatus of this invention.

FIG. 1D depicts a block diagram of another embodiment of a film based apparatus of this invention.

FIG. 1E depicts a block diagram of another embodiment of a film based apparatus of this invention.

FIG. 2A-H depict embodiments of films for use in the apparatuses of FIGS. 1A-E.

FIG. 3A depicts an expanded view of a station of FIGS. 1A-E.

FIG. 3B depicts an expanded view of a station of FIGS. 1A-D.

FIG. 3C depicts an expanded view of a viewing field of FIGS. 1A-D.

FIG. 3D depicts an expanded view of a viewing field of FIG. 1E.

FIG. 4A depicts a block diagram of another embodiment of a rigid substrate based apparatus of this invention.

FIG. 4B depicts a block diagram of another embodiment of a rigid substrate based apparatus of this invention.

FIG. 4C depicts a block diagram of another embodiment of a rigid substrate based apparatus of this invention.

FIG. 4D depicts a block diagram of another embodiment of a rigid substrate based apparatus of this invention.

FIG. 5A-H depict embodiments of films for use in the apparatuses of FIGS. 4A-D.

FIG. 6A-D depict an embodiment of a disk-based apparatus of this invention.

FIGS. 7A&B depicts an embodiment of a disk for use of the disk-based apparatus of FIGS. 6A-D.

FIG. 7B depicts another embodiment of a disk for use of the disk-based apparatus of FIGS. 6A-D.

FIG. 8A-J depict camera images and anti-correlated donor-acceptor events as the viewing field is moved in a controlled linear manner.

### DETAILED DESCRIPTION OF THE INVENTION

The inventors have found an apparatus can be constructed for automated binding, initiating, reacting and detecting reactions at one or a plurality of single molecular sites (sites comprising one molecule or a molecular assemblage, complex or other collection of molecules and/or atoms). In certain embodiments, the automated apparatus is designed to bind, initiate, synthesize and sequence naturally occurring or man-made macromolecules including biomacromolecules such as oligonucleotides, polynucleotides, genes, chromosomes, or similar nucleic acid materials, polypeptides, proteins, enzymes, or similar amino acid containing materials, oligosaccharides, polysaccharides, starches or other sugar containing materials or biomolecules containing a mixture of nucleotides, amino acids, saccharides (sugars) such as ribozymes, RNA/DNA mixed nucleic acids, modified proteins (glycated, phosphorylated, etc.) and synthetic or man-made analogs thereof. The inventors have also found that apparatus can be used to automate sequencing, synthesis and analysis of the above-listed biomolecules or can be used as a computer memory—storing and retrieving information at the molecular level, or can be used to detect and monitor reactions, interactions or other detectable molecular events at the single molecule level.

The apparatus includes a continuous substrate containing zones adapted to have molecular species immobilized on the surface of the zone or in a matrix formed on the zone, where the molecular species can be any molecular component of a reaction system. In the case of sequencing of nucleic acids, the apparatus comprises either a DNA or RNA primer sequence adapted to hybride with an anti-sense nucleotide sequence of an unknown nucleic acid to form a duplex capable of extension with a polymerizing agent. The continuous substrate is designed to move so that each zone can be passed through a plurality of stations. Some of the stations are reagent introduction stations and others are detector stations. The continuous substrate is passed through one or more reagent introduction stations, where one or more reagents are introduced into or onto each zone as the zone passes through the station. In these stations, pre-active molecular sites are formed, generally by binding one or more of the reagents sparely to binding sites on the surface of the zones or in a matrix formed on the surface of the zones. Once all the necessary reagents have been introduced into or onto the zones to form pre-reactive molecular assemblages sparely bound in the zones, then the substrate is passed through a mapping station, where reactive bound molecular assemblages are mapped—their locations are determined relative to a detection grid used for alignment and calibration or registration of the mapped reactive species. Although the molecules themselves can include detectable groups or moieties, in certain embodiments, the substrate include detectable groups associated with spare binding sites. In other embodiments, one or more of the bound molecules in the bound molecular assemblages includes a detectable group. Once the mapping is complete, the final reagent and/or reagents are added to the zones by passing the zone through a reaction initiation station. After the final reagent(s) is(are) added to the zones, the desired reaction starts. As the reaction is occurring, the zones passes through a second detection station, where signal data is collected evidencing reaction events that occur within the zone during a given detection period.

The present invention broadly relates to an apparatus including: (a) a continuous substrate including zones including sparely distributed binding sites; (b) one reagent station or a plurality of reagent stations adapted to introduce one reaction reagent or a plurality of reagents onto and/or into the zones and to form bound pre-reactive molecular sites onto and/or in reagent or a plurality of bound reagents, (c) a first detector station adapted to locate single molecular pre-reactive sites inside the zones, (d) an initiation station adapted to introduce one initiation reagent or a plurality of initiation reagents onto and/or into the zones to form reactive molecular sites, (e) a second detector station adapted to monitor reaction events at one, some or all of the located reactive molecular sites inside the zones, and (f) an analyzer station adapted to receive signals from the detector stations and convert the signals into output data corresponding to and characterizing the detected events inside the zones, where the continuous substrate is designed to be moved through the stations.

The present invention broadly relates to methods for detecting reactions sequencing, synthesizing or analyzing biomolecules including the steps of (a) forming a continuous substrate including zones including sparely distributed binding sites; (b) moving the continuous substrate past one reagent station or a plurality of reagent stations adapted to introduce one precursor reagent or a plurality of precursor reagents onto and/or into the zones to form a plurality of bound sparely distributed pre-reactive molecular sites, where each site includes a detectable group or moiety associated with the binding sites and/or one or more of the reagents; (d) moving the substrate past a mapping station adapted to map or locate detectable single pre-reactive molecular sites inside the zones; (e) moving the substrate past an initiation station adapted to introduce one initiation reagent or a plurality of initiation reagents onto and/or into the zones to form detectable reactive molecular sites; (f) moving the substrate past a second detector station adapted to detect reaction events at one, some or all of the located detectable reactive molecular sites inside the zones, and (g) forwarding output signals from the two detectors to an analyzer station adapted to receive signals from the detector stations and convert the signals into output data corresponding to and characterizing the detected events inside the zones.

The present invention relates to a continuous process single molecule DNA sequencer analyzer. Oligonucleotide primers labeled with a red fluor are immobilized to a flexible derivatized plastic substrate. This substrate moves from spool A through a series of reaction chambers that are serviced by reagent cassettes. Solution exchange is facilitated by vacuum at the gray junctions. The processed substrate moves in discrete steps across two dove prisms that are properly positioned to illuminate the aqueous interface by evanescence (TIRE). Additional reagents can be added if needed (e.g., dNTPs). In the example above, polymerase is added prior to substrate interrogation and photobleaching at a first objective station, labeled-dNTPs are then added, and FRET events are subsequently detected at a second objective station. The modular nature of the design is compatible with multiple chemistries. Reaction time is a function of the length of individual reaction chambers. The objective the image capture station is fixed such that immobilized reaction complexes are in the focal plane. A dove prism is fixed such that incident light strikes the substrate-aqueous interface at the critical angle for total internal reflection. The reaction volume of the image capture station is determined by surface topography generated during photolithography and surface modification.

The substrate tape as it passes by the objectives is held in place by a vacuum manifold behind the tape that secures the reaction zone flat against the prism. A thin film of microscope oil between the tape and the prism reduces the refractive index change across the junction. Registration marks along the edges of the tape address each zone. Smaller registrations marks within the zone permit superimposition of fields at single pixel resolution (possible in software).

Diagram of a single reaction zone on the substrate. Spots are regions of immobilized unique octamer primers in a systematic order. In a single reaction zone, all 65,000 possible combinations are represented.

### Sequencing

Bound Primer

The present invention also provides an apparatus for analyzing small, medium or large ensembles of reactive sequencing sites or a single reactive sequencing site in a continuous reaction mode, an intermittent reaction mode, a periodic reaction mode, semi-periodic reaction mode, or a mixed mode format (a mixture of one or more of the other modes in any combination or permutation). The apparatus includes a continuous substrate including zones having disposed therein one or a sparsely distributed plurality of a bound nucleotide primers, where the primers are bound via corresponding sparsely distributed binding agents in or on the zones. The binding sites can also include a marker associated therewith so that each binding site can be located by the mapping station. The association can be a marker bonded to the binding site or can be bonded to a site of the zone proximate the binding sites. The binding sites can also be nano-particle donors such as fluorescently active and long lived quantum dots. The primers are adapted to form duplexes to a nucleic acid to be sequenced, a template. The zones can includes a plurality of different nucleotide primers adapted to form duplexes with a plurality of different nucleic acids to be sequenced, different templates, so that multiple templates can be sequenced simultaneously within the same zone. In certain embodiments, the zones are spaced apart along a length or along a length and a width of the substrate, while in other embodiments the zones are continuous.

The apparatus also includes a nucleic acid delivery or introduction station adapted to introduce the nucleic acid or nucleic acids (template(s)) onto and/or into the zones, where the primer hybridizes/anneals to the template to form primer/template duplexes and a polymerizing agent delivery or introduction station adapted to introduce a polymerizing agent onto and/or into the zones. The result of the introduction of the polymerizing agent to the zone is the formation of bound single pre-active molecular sequencing complex sites within the zones at least one member of the complexes has associated therewith a detectable agent such as a tag, label, moiety, group or the like, having a detectable property. The term associated with means that the detectable agent is either covalently bonded to one or more of the members of the complexes or is covalently bonded to a moiety used to anchor the bound member of the complex in the zones or is an agent fixed in the zone proximate each bound pre-active sequencing complex.

The apparatus also includes a first detection station adapted to locate or map detectable agents associated with the pre-active sequencing complexes within a viewing field of a detector associated with the station, where the field comprise the entire zone or a portion thereof. The first detection station is adapted to superimpose the located or mapped complexes to a grid corresponding to image of the detector. For camera, the grid represent pixels of a camera image of the viewing field. The apparatus also includes an initiation station adapted to introduce dNTPs for the polymerizing agent (generally four different types, but also for non-natural nucleic acids that include more the four base types) onto and/or into the zones. At least one dNTP includes a detectable agent such as a tag, label, moiety or group, covalently bonded thereto either directly or indirectly via a linker and having a detectable property. The dNTP can include other added groups or moieties that are designed to augment incorporation timing (duration of incorporation) or other characteristics of the dNTP. The apparatus also include a second detection station adapted to monitor and/or detect dNTP/complex events including incorporation events, binding events, misincorporation events, collision event, etc., occurring at one, some or all of the mapped complexes within the field. The apparatus also includes an analyzer adapted to receive signals from the detection stations and to convert the signals into output data corresponding to a nucleotide sequence of the template. The detection can be a change in the detectable property of all detectable agents or any subset thereof before, during and/or after one or a series of dNTP/complex events including incorporation events, a conversion of an agent associated with the dNTP after one or a series of dNTP incorporations into a detectable agent, or due to an interaction between the detectable agent associated with the complexes and the detectable agent associated with the dNTPs.

Bound Polymerizing Agent

The present invention also provides an apparatus for analyzing small, medium or large ensembles of reactive sequencing sites or a single reactive sequencing site in a continuous reaction mode, an intermittent reaction mode, a periodic reaction mode, semi-periodic reaction mode, or a mixed mode format (a mixture of one or more of the other modes in any combination or permutation). The apparatus includes a continuous substrate including zones having disposed therein and/or thereon one or a plurality of sparsely distributed bound nucleotide polymerizing agents (same or different), where the polymerizing agent is bound or immobilized via one or a sparsely distributed plurality of binding agent in or on the zones. In certain embodiments, the zones are spaced apart along a length or along a length and a width of the film, while in other embodiments, the zones are continuous. The apparatus also includes a duplex station adapted to introduce primer-sample nucleic acid duplexes. The result of the introduction of the duplexes to the bound polymerizing agents is the formation of bound sparsely distributed sequencing complexes within the zones, where either the nucleic acid, primer, the polymerizing agent, the binding agent and/or the zones include the same or different detectable atomic or molecular tag or label. The apparatus also includes a first detector station adapted to locate or map reactive sequencing complexes within the zones and map them relative to a grid for calibration and registration. The apparatus also includes an initiation station adapted to introduce dNTPs for the polymerizing agent (generally four different types, but for non-natural DNA, RNA, or DNA/RNA nucleic acids that include more than the four natural base types) onto and/or into the zones. One or all of the dNTP types may include the same or different atomic or molecular tag or label. The apparatus also includes a second detector station adapted to monitor and detect dNTP incorporation events occurring at one, some or all of the located or mapped reactive sequencing complexes or sites inside the zones. The apparatus also includes an analyzer station adapted to receive signals from the detector stations and convert the signals into output data corresponding to a nucleotide sequence of the sample (template) nucleic acid.

Bound Nucleic Acid

The present invention also provides an apparatus for analyzing small, medium or large ensembles of reactive sequencing sites or a single reactive sequencing site in a continuous reaction mode, an intermittent reaction mode, a periodic reaction mode, semi-periodic reaction mode, or a mixed mode format (a mixture of one or more of the other modes in any combination or permutation). The apparatus includes a continuous substrate including zones having disposed therein and/or thereon one or a plurality of sparsely distributed bound nucleic acids of unknown sequence via one or a sparse plurality of binding agent in or on the zones. In certain embodiments, the zones are spaced apart along a length or along a length and a width of the substrate, while in other embodiments, the zones are continuous. The apparatus also includes a primer/polymerizing agent station adapted to introduce a primer and a polymerizing agent. The result of the introduction of the primer and the polymerizing agent to the bound nucleic acid is the formation of bound sparsely distributed sequencing complexes within the zones. Alternatively, the apparatus can include a primer station adapted to introduce primer into or onto the zones to form duplexes with the bound nucleic acid, followed by the introduction of polymerizing agent to form sequencing complexes. Either the nucleic acid, primer, the polymerizing agent, the binding agent and/or the zones include the same or different detectable atomic or molecular tag or label so that some or all of the sequencing complexes can be detected and monitored in detectors stations. The apparatus may also include a first detector station adapted to locate or map isolated reactive sequencing complexes within the zones and map them relative to a grid for calibration and registration. The apparatus also includes an initiation station adapted to introduce dNTPs for the polymerizing agent (generally four different types, but for non-natural DNA, RNA, or DNA/RNA nucleic acids that include more the four base types) onto and/or into the zones. One or all of the dNTP types may include the same or different atomic or molecular tag or label. The apparatus also includes a second detector station adapted to monitor and detect dNTP incorporation events occurring at one, some or all of the located or mapped reactive sequencing complexes or sites inside the zones. The apparatus also includes an analyzer station adapted to receive signals from the detector stations and convert the signals into output data corresponding to a nucleotide sequence of the sample (template) nucleic acid.

For additional information on DNA sequencing, data acquisition and analysis, monomers, monomers synthesis, or other features of system that are amenable to detection using the apparatuses and methods of this invention, the reader is referred to Published patent application and Pending patent application Ser. Nos. 09/901,782; 10/007,621; 11/007,794; 11/671,956; 11/694,605; 2006-0078937; U.S. Pat. Nos. 6,982,146; 7,169,560; 7,220,549, 20070070349; 20070031875; 20070012113; 20060286566; 20060252077; 20060147942; 200601336144; 20060024711; 20060024678; 20060012793; 20060012784; 20050100932; incorporated herein by reference.

For additional information on DNA sequencing, data acquisition and analysis, monomers, monomers synthesis, or other features of system that are amenable to detection using the apparatuses and methods of this invention, the reader is referred to Published patent application and Pending patent application Ser. Nos. 09/901,782; 10/007,621; 11/007,794; 11/671,956; 11/694,605; 2006-0078937; U.S. Pat. Nos. 6,982,146; 7,169,560; 7,220,549, 20070070349; 20070031875; 20070012113; 20060286566; 20060252077; 20060147942; 200601336144; 20060024711; 20060024678; 20060012793; 20060012784; 20050100932; incorporated herein by reference.

Although the apparatuses and method described above are illustrated using polymerizing agents so that the events being detected are events that result in the formation of oligomeric or polymeric products at least for those system that produce a sequence specific product, the apparatus and methods can be equally well be applied to depolymerizing system where an oliogomer or polymer is depolymerized step wise with each removed monomer unit being detected before, during and/or after remove to permit identification of the removed monomer.

### Suitable Reagents

Suitable substrates include, without limitation, flexible substrates or rigid substrates, where the substrates have disposed on one surface: (1) sparsely distributed bonding sites for immobilizing one or more precursor reagents, (2) a single layered or multi-layered matrix including sparsely distributed bonding sites therein or in/on the top layer; (3) a continuous matrix including sparsely distributed bonding sites therein/thereon; (4) a heterogeneous matrix including sparsely distributed bonding sites therein/thereon; or (5) any other coating on the substrate surface that can support sparsely distributed bonding sites therein/thereon. The term sparsely as used therein means that the sites are spaced apart sufficient that resulting immobilized pre-reactive molecular assemblages can be separately and distinctly detected and monitored in the apparatus. The distribution can be random or patterned.

Suitable flexible substrates include any polymer having sufficient strength to be wound and unwound on to reels or can be pulled through a single pass apparatus and being transparent to light within the detection range. Suitable polymers include, without limitation, polyolefins, polyacrylates, polystyrenes, polyamides, polyimides, polyalkylene oxides, polyacids, polycarbonates, polylactones, or any other structure plastic or polymer.

Suitable rigid substrates include glass, ceramics, metals, or other rigid materials. Suitable glass include quartz or any glass such as slide glass, cover slip glass, pyrex, borosilicate glass, any other rigid glass or mixture or combinations thereof. Suitable ceramics include silicates, aluminates, silica-aluminas, alumina-silicas, titania-alumina-silicates, zirconates, titanates, or any other ceramic substrate. Suitable metals include any metal substrate that can support bonding sites and/or layers or matrices. Suitable matrices also includes matrices the enhance fluorescence or decrease background or noise.

Suitable substrates include, without limitation, flexible substrates or rigid substrates, where the substrates have disposed on one surface: (1) sparsely distributed bonding sites for immobilizing one or more precursor reagents, (2) a single layered or multi-layered matrix including sparsely distributed bonding sites therein or in/on the top layer; (3) a continuous matrix including sparsely distributed bonding sites therein/thereon; (4) a heterogeneous matrix including sparsely distributed bonding sites therein/thereon; or (5) any other coating on the substrate surface that can support sparsely distributed bonding sites therein/thereon. The term sparsely as used therein means that the sites are spaced apart sufficient that resulting immobilized pre-reactive molecular assemblages can be separately and distinctly detected and monitored in the apparatus. The distribution can be random or patterned.

Suitable flexible substrates include any polymer having sufficient strength to be wound and unwound on to reels or can pulled through a single pass apparatus and being transparent to light within the detection range. Suitable polymers include, without limitation, polyolefins, polyacrylates, polystyrenes, polyamides, polyimides, polyalkylene oxides, polyacids, polycarbonates, polylactones, or any other structure plastic or polymer or mixtures or combinations thereof.

Suitable rigid substrates include glass, ceramics, metals, or other rigid materials. Suitable glass include quartz or any glass or mixtures or combinations thereof. Suitable ceramics include silicates, aluminates, silica-aluminas, alumina-silicas, titania-alumina-silicates, zirconates, titanates, or any other ceramic substrate or mixtures or combinations thereof. Suitable metals include any metal substrate that can support bonding sites and/or layers or matrices or mixtures or combinations thereof.

Suitable polymerizing agents for use in this invention include, without limitation, any polymerizing agent that polymerizes monomers relative to a specific template such as a DNA or RNA polymerase, reverse transcriptase, or the like or that polymerizes monomers in a step-wise fashion or mixtures or combinations thereof.

Suitable polymerases for use in this invention include, without limitation, any polymerase that can be isolated from its host in sufficient amounts for purification and use and/or genetically engineered into other organisms for expression, isolation and purification in amounts sufficient for use in this invention such as DNA or RNA polymerases that polymerize DNA, RNA or mixed sequences, into extended nucleic acid polymers. In certain embodiments, polymerases for use in this invention include mutants or mutated variants of native polymerases where the mutants have one or more amino acids replaced by amino acids amenable to attaching an atomic or molecular tag, which have a detectable property. Exemplary DNA polymerases include, without limitation, HIV1-Reverse Transcriptase using either RNA or DNA templates, DNA pol I from T. aquaticus or E. coli, Bateriophage T4 DNA pot, T7 DNA pot, phi29, any other isolated and available polymerase or transcriptase, variants of any these polymerases, or the like or mixture or combinations thereof. Exemplary RNA polymerases include, without limitation, T7 RNA polymerase or the like.

Suitable depolymerizing agents for use in this invention include, without limitation, any depolymerizing agent that depolymerizes monomers in a step-wise fashion such as exonucleases in the case of DNA, RNA or mixed DNA/RNA polymers, proteases in the case of polypeptides and enzymes or enzyme systems that sequentially depolymerize polysaccharides.

Suitable monomers for use in this invention include, without limitation, any monomer that can be step-wise polymerized into a polymer using a polymerizing agent. Suitable nucleotides for use in this invention include, without limitation, naturally occurring nucleotides, synthetic analogs thereof, analog having atomic and/or molecular tags attached thereto, or mixtures or combinations thereof.

Suitable detectable agents include, without limitation, any group that is detectable by a known or yet to be invented analytical technique. Exemplary examples include, without limitation, fluorophores or chromophores, groups including one or a plurality of nmr active atoms (²H, ¹¹B, ¹³C, ¹⁵N, ¹⁷O, ¹⁹F, ²⁷Al, ²⁹Si, ³¹P, NMR active transition metals, NMR active actinide metals, NMR active lanthanide metals), IR active groups, nearIR active groups, Raman active groups, UV active groups, X-ray active groups, light emitting quantum dots, light emitting nano-structures, or other structures or groups capable of direct detection or that can be rendered detectable or mixtures or combinations thereof.

Suitable atomic tag for use in this invention include, without limitation, any atomic element or structure or system amenable to being attached to a specific site in a polymerizing agent or dNTP, especially Europium shift agents, NMR active atoms or the like.

Suitable atomic tag for use in this invention include, without limitation, any atomic element amenable to attachment to a specific site in a polymerizing agent or dNTP, especially Europium shift agents, nmr active atoms or the like or mixtures or combinations thereof.

Suitable molecular tag for use in this invention include, without limitation, any molecule amenable to being attached to a specific site in a polymerizing agent or monomer, especially fluorescent dyes such as d-Rhodamine acceptor dyes including dichloro [R110], dichloro[R6G], dichloro [TAMRA], dichloro [ROX] or the like, fluorescein donor dye including fluorescein, 6-FAM, or the like; Acridine including Acridine orange, Acridine yellow, Proflavin, or the like; Aromatic Hydrocarbon including 2-Methylbenzoxazole, Ethyl p-dimethylaminobenzoate, Phenol, benzene, toluene, or the like; Arylmethine Dyes including Auramine O, Crystal violet, H2O, Crystal violet, Malachite Green or the like; Coumarin dyes including 7-Methoxycoumarin-4-acetic acid, Coumarin 1, Coumarin 30, Coumarin 314, Coumarin 343, Coumarin 6 or the like; Cyanine Dye including 1,1′-diethyl-2,2′-cyanine iodide, Cryptocyanine, Indocarbocyanine (C3)dye, Indodicarbocyanine (C5)dye, Indotricarbocyanine (C7)dye, Oxacarbocyanine (C3)dye, Oxadicarbocyanine (C5)dye, Oxatricarbocyanine (C7)dye, Pinacyanol iodide, Stains all, Thiacarbocyanine (C3)dye, Thiacarbocyanine (C3)dye, Thiadicarbocyanine (C5)dye, Thiatricarbocyanine (C7)dye, or the like; Dipyrrin dyes including N,N′-Difluoroboryl-1,9-dimethyl-5-(4-iodophenyl)-dipyrrin, N,N′-Difluoroboryl-1,9-dimethyl-5-[(4-(2-trimethylsilylethynyl), N,N′-Difluoroboryl-1,9-dimethyl-5-phenydipyrrin, or the like; Merocyanines including 4-(dicyanomethylene)-2-methyl-6-(p-dimethylaminostyryl)-4H-pyran (DCM), 4-(dicyanomethylene)-2-methyl-6-(p-dimethylaminostyryl)-4H-pyran (DCM), 4-Dimethylamino-4′-nitrostilbene, Merocyanine 540, or the like; Miscellaneous Dye including 4′,6-Diamidino-2-phenylindole (DAPI), 4′,6-Diamidino-2-phenylindole (DAPI), 7-Benzylamino-4-nitrobenz-2-oxa-1,3-diazole, Dansyl glycine, H2O, Dansyl glycine, Hoechst 33258, Hoechst 33258, Lucifer yellow CH, Piroxicam, Quinine sulfate, Quinine sulfate, Squarylium dye III, or the like; Oligophenylenes including 2,5-Diphenyloxazole (PPO), Biphenyl, POPOP, p-Quaterphenyl, p-Terphenyl, or the like; Oxazines including Cresyl violet perchlorate, Nile Blue, Nile Red, Nile blue, Oxazine 1, Oxazine 170, or the like; Polycyclic Aromatic Hydrocarbons including 9,10-Bis(phenylethynyl)anthracene, 9,10-Diphenylanthracene, Anthracene, Naphthalene, Perylene, Pyrene, or the like; polyene/polyynes including 1,2-diphenylacetylene, 1,4-diphenylbutadiene, 1,4-diphenylbutadiyne, 1,6-Diphenylhexatriene, Beta-carotene, Stilbene, or the like; Redox-active Chromophores including Anthraquinone, Azobenzene, Benzoquinone, Ferrocene, Riboflavin, Tris(2,2′-bipyridyl)ruthenium(II), Tetrapyrrole, Bilirubin, Chlorophyll a, Chlorophyll b, Diprotonated-tetraphenylporphyrin, Hematin, Magnesium octaethylporphyrin, Magnesium octaethylporphyrin (MgOEP), Magnesium phthalocyanine (MgPc), PrOH, Magnesium phthalocyanine (MgPc), pyridine, Magnesium tetramesitylporphyrin (MgTMP), Magnesium tetraphenylporphyrin (MgTPP), Octaethylporphyrin, Phthalocyanine (Pc), Porphin, Tetra-t-butylazaporphine, Tetra-t-butylnaphthalocyanine, Tetrakis(2,6-dichlorophenyl)porphyrin, Tetrakis(o-aminophenyl)porphyrin, Tetramesitylporphyrin (TMP), Tetraphenylporphyrin (TPP), Vitamin B12, Zinc octaethylporphyrin (ZnOEP), Zinc phthalocyanine (ZnPc), Zinc tetramesitylporphyrin (ZnTMP), Zinc tetramesitylporphyrin radical cation, Zinc tetraphenylporphyrin (ZnTPP), or the like; Cy3, Cy3B, Cy5, Cy5.5, Atto590, Atto610, Atto611, Atto611x, Atto620, Atto655, Alexa488, Alexa546, Alexa594, Alexa610, Alexa610x, Alexa633, Alexa647, Alexa660, Alexa680, Alexa700, Bodipy630, DY610, DY615, DY630, DY632, DY634, DY647, DY680, DyLight647, HiLyte647, HiLyte680, LightCycler (LC) 640, Oyster650, ROX, TMR, TMR5, TMR6; Xanthenes including Eosin Y, Fluorescein, Fluorescein, Rhodamine 123, Rhodamine 6G, Rhodamine B, Rose bengal, Sulforhodamine 101, or the like; or mixtures or combination thereof or synthetic derivatives thereof or FRET fluorophore-quencher pairs including FB1 (5′-FAM/3′-BHQ-1) DLO-TEB1 (5′-TET/3′-BHQ-1), DLO-JB1 (5′-JOE/3′-BHQ-1), DLO-HB1 (5′-HEX/3′-BHQ-1), DLO-C3B2 (5′-Cy3/Y-BHQ-2), DLO-TAB2 (5′-TAMRA/3′-BHQ-2), DLO-RB2 (5′-ROX/3′-BHQ-2), DLO-C5B3 (5′-Cy5/3′-BHQ-3), DLO-C55B3 (5′-Cy5.5/3′-BHQ-3), MBO-FB1 (5′-FAM/3′-BHQ-1), MBO-TEB1 (5′-TET/3′-BHQ-1), MBO-JB1 (5′40E/3′-BHQ-1), MBO-HB1 (5′-HEX/3′-BHQ-1), MBO-C3B2 (5′-Cy3/3′-BHQ-2), MBO-TAB2 (5′-TAMRA/3′-BHQ-2), MBO-RB2 (5′-ROX/3′-BHQ-2); MBO-C 5B3 (5′-Cy5/3′-BHQ-3), MBO-C55B3 (5′-Cy5.5/3′-BHQ-3) or similar FRET pairs available from

Biosearch Technologies, Inc. of Novato, Calif., fluorescent quantum dots (stable long lived fluorescent donors), tags with NMR active groups, Raman active tags, tags with spectral features that can be easily identified such as IR, far IR, near IR, visible UV, far UV or the like. It should be recognized that any molecule, nano-structure, or other chemical structure that is capable of chemical modification and includes a detectable property capable of being detected by a detection system. Such detectable structure can include one presently known and structures that are being currently designed and those that will be prepared in the future.

### Suitable Detection System

Suitable single molecule detection systems or methodologies that can be detected in the apparatuses of this invention includes, without limitation, those described in U.S. patent and patent application Ser. No. 09/901,782 filed Jul. 9, 2001; 10/007,621 filed Dec. 3, 2001; 11/089,822 filed Mar. 25, 2005; 09/572,530; 11/089,871 filed Mar. 25, 2005; 11/089,875 filed Mar. 25, 2005; 10/358,818; U.S. Pat. Nos. 7,056,676; 7,056,661; 7,052,847; 7,033,764; 7,018,819; 6,989,235; 6,985,223; 6,982,165; 6,982,149; 6,962,778; 6,936,702; 6,927,065; 6,919,333; 6,869,764; 6,858,436; 6,828,786; 6,818,395; 6,811,977; 6,790,671; 6,767,716; 6,762,048; 6,762,025; 6,743,578; 6,723,552; 6,714,294; 6,649,404; 6,635,470; 6,632,609; 6,608,314; 6,608,228; 6,607,888; 6,573,089; 6,537,755; 6,528,258; 6,455,861; 6,448,015; 6,403,311; 6,388,746; 6,369,928; 6,355,420; 6,331,617; 6,329,150; 6,316,229; 6,313,914; 6,306,607; 6,296,810; 6,287,772; 6,287,765; 6,274,313; 6,267,913; 6,265,166; 6,255,083; 6,248,518; 6,232,075; 6,226,082; 6,221,592; 6,210,896; 6,143,495; 6,110,676; 6,049,380; 5,898,493; 5,674,743; 5,646,731; 5,558,998; 5,538,850; 5,514,596; 5,437,840; 5,405,747; 5,329,461; 5,322,796; 20060154288; 20060147942; 20060147941; 20060147927; 20060141531; 20060141268; 20060136144; 20060134679; 20060134666; 20060126921; 20060121442; 20060118754; 20060109546; 20060109461; 20060103840; 20060099648; 20060098927; 20060098705; 20060094030; 20060078998; 20060078937; 20060078915; 20060077382; 20060072114; 20060068440; 20060063264; 20060063173; 20060062531; 20060062440; 20060061762; 20060061755; 20060061754; 20060057606; 20060054982; 20060050268; 20060046313; 20060046311; 20060046291; 20060046258; 20060033038; 20060024678; 20060019276; 20060019267; 20060019263; 20060017918; 20060014191; 20060012793; 20060012784; 20060008799; 20060008227; 20060003333; 20050282173; 20050281682; 20050280817; 20050279927; 20050276535; 20050272159; 20050266584; 20050266583; 20050266478; 20050266456; 20050266424; 20050260653; 20050260614; 20050255580; 20050244863; 20050244821; 20050238286; 20050233417; 20050221510; 20050221509; 20050221508; 20050221506; 20050221408; 20050221319; 20050213090; 20050208574; 20050208557; 20050208491; 20050207018; 20050206892; 20050202468; 20050202466; 20050202464; 20050196790; 20050186619; 20050186576; 20050181383; 20050181379; 20050180678; 20050176228; 20050176029; 20050170367; 20050164264; 20050164255; 20050164205; 20050164181; 20050158877; 20050158761; 20050153354; 20050153284; 20050147992; 20050147980; 20050147979; 20050147977; 20050147976; 20050147963; 20050142595; 20050142567; 20050136419; 20050130150; 20050123974; 20050123944; 20050112671; 20050112620; 20050112595; 20050112579; 20050110990; 20050089993; 20050089924; 20050089920; 20050089901; 20050089890; 20050087122; 20050084980; 20050074779; 20050074774; 20050069895; 20050053974; 20050053966; 20050048581; 20050048498; 20050042665; 20050042649; 20050042639; 20050042633; 20050042615; 20050031545; 20050027166; 20050019784; 20050014175; 20050009004; 20050003376; 20050003359; 20040265392; 20040262636; 20040259094; 20040259082; 20040252957; 20040248161; 20040248144; 20040246572; 20040241681; 20040234958; 20040224325; 20040217297; 20040215087; 20040214221; 20040214211; 20040196569; 20040191778; 20040181344; 20040174521; 20040166593; 20040166514; 20040161369; 20040151631; 20040146849; 20040142386; 20040137510; 20040135997; 20040126790; 20040120455; 20040115838; 20040110208; 20040101891; 20040099813; 20040096981; 20040096887; 20040091903; 20040082080; 20040080750; 20040077090; 20040077075; 20040072200; 20040065806; 20040053399; 20040046120; 20040043506; 20040042937; 20040029288; 20040019104; 20040014033; 20040012780; 20040009612; 20040009510; 20040005613; 20040005582; 20030235900; 20030235854; 20030235849; 20030231304; 20030228682; 20030219765; 20030215864; 20030215844; 20030206297; 20030203502; 20030194740; 20030190647; 20030186276; 20030186255; 20030186227; 20030181658; 20030174992; 20030174923; 20030173647; 20030166851; 20030165929; 20030162181; 20030160151; 20030158474; 20030149153; 20030148344; 20030146091; 20030143614; 20030143549; 20030143219; 20030138831; 20030134807; 20030134794; 20030134298; 20030124592; 20030124576; 20030123883; 20030123155; 20030123058; 20030121764; 20030119168; 20030119002; 20030104588; 20030100102; 20030098248; 20030096231; 20030095893; 20030095259; 20030092005; 20030068629; 20030065155; 20030064400; 20030064366; 20030059820; 20030054396; 20030054181; 20030052006; 20030044781; 20030040173; 20030036204; 20030026735; 20030008372; 20030008295; 20020197736; 20020197735; 20020197639; 20020196442; 20020192649; 20020187508; 20020182651; 20020182627; 20020168678; 20020167665; 20020164629; 20020160400; 20020150938; 20020143167; 20020137057; 20020126276; 20020123050; 20020119455; 20020118005; 20020115076; 20020110843; 20020105641; 20020104759; 20020102596; 20020102595; 20020102568; 20020098124; 20020094526; 20020081744; 20020081605; 20020070349; 20020061526; 20020058273; 20020058256; 20020052040; 20020042071; 20020039738; 20020039737; 20020034757; 20020030811; 20020025529; 20020013250; 20020012933; 20020012930; 20020001810; 20020001768; 20010018184; 20010007985; 20010002315; 20060154288; 20060141531; 20060134666; 20060098927; 20060094030; 20060078937; 20060063264; 20060063173; 20060062531; 20060061755; 20060061754; 20060057606; 20060046291; 20060019267; 20060014191; 20060008799; 20060008227; 20060003333; 20050280817; 20050266584; 20050266583; 20050266424; 20050260614; 20050244821; 20050221408; 20050208557; 20050208491; 20050202466; 20050186619; 20050170367; 20050164255; 20050164205; 20050158761; 20050089901; 20050089890; 20050074779; 20050048581; 20050042633; 20050031545; 20040265392; 20040262636; 20040259082; 20040252957; 20040246572; 20040241681; 20040174521; 20040166514; 20040151631; 20040096887; 20040072200; 20040043506; 20040019104; 20040014033; 20030235854; 20030235849; 20030215844; 20030203502; 20030194740; 20030186255; 20030174923; 20030165929; 20030158474; 20030143614; 20030134807; 20030124592; 20030104588; 20030092005; 20030064400; 20030064366; 20030054181; 20030044781; 20020192649; 20020168678; 20020167665; 20020164629; 20020137057; 20020126276; 20020119455; 20020115076; 20020104759; 20020102596; 20020070349; 20020052040; 20020042071; 20020039738; 20020034757; 20020013250; 20010018184; 7,076,092; 7,060,419; 7,056,676; 7,056,670; 7,056,661; 7,052,847; 7,052,616; 7,049,148; 7,041,812; 7,038,856; 7,033,781; 7,033,764; 7,019,828; 7,018,819; 7,013,054; 6,995,348; 6,992,300; 6,989,897; 6,989,542; 6,989,235; 6,985,223; 6,982,165; 6,982,149; 6,982,146; 6,980,294; 6,972,173; 6,970,239; 6,962,778; 6,944,407; 6,939,663; 6,936,702; 6,934,030; 6,932,940; 6,929,779; 6,927,070; 6,927,065; 6,919,333; 6,917,726; 6,916,665; 6,911,345; 6,882,767; 6,869,764; 6,858,436; 6,850,323; 6,846,638; 6,844,154; 6,841,096; 6,838,121; 6,828,800; 6,828,786; 6,828,100; 6,818,959; 6,818,395; 6,811,977; 6,809,816; 6,806,455; 6,794,659; 6,790,671; 6,787,308; 6,781,690; 6,771,367; 6,767,716; 6,762,059; 6,762,048; 6,762,025; 6,761,962; 6,760,109; 6,759,247; 6,749,813; 6,743,578; 6,723,552; 6,714,294; 6,713,260; 6,707,548; 6,696,299; 6,689,529; 6,685,885; 6,685,810; 6,673,577; 6,669,906; 6,649,683; 6,649,404; 6,635,470; 6,632,609; 6,610,649; 6,610,504; 6,608,716; 6,608,314; 6,608,228; 6,607,888; 6,603,546; 6,599,703; 6,582,907; 6,582,903; 6,573,089; 6,537,755; 6,529,275; 6,528,801; 6,528,258; 6,524,829; 6,515,120; 6,459,093; 6,455,861; 6,453,245; 6,448,015; 6,438,279; 6,432,361; 6,428,667; 6,426,231; 6,418,382; 6,410,239; 6,403,311; 6,395,478; 6,391,559; 6,388,746; 6,387,234; 6,381,025; 6,376,180; 6,376,177; 6,375,871; 6,369,928; 6,355,420; 6,331,617; 6,329,150; 6,316,229; 6,313,914; 6,310,352; 6,306,607; 6,296,810; 6,287,772; 6,287,765; 6,280,933; 6,274,320; 6,274,313; 6,267,913; 6,265,166; 6,258,568; 6,258,533; 6,255,083; 6,255,048; 6,248,518; 6,246,046; 6,232,075; 6,231,812; 6,226,082; 6,221,592; 6,218,657; 6,210,896; 6,210,891; 6,204,068; 6,190,889; 6,190,868; 6,180,415; 6,177,277; 6,143,496; 6,143,495; 6,141,657; 6,140,041; 6,110,676; 6,083,693; 6,057,101; 6,049,380; RE36,529; 6,004,771; 6,002,471; 6,001,566; 5,972,693; 5,958,673; 5,945,312; 5,898,493; 5,885,813; 5,871,697; 5,866,331; 5,858,671; 5,834,204; 5,827,663; 5,804,384; 5,799,682; 5,763,162; 5,754,511; 5,674,743; 5,658,749; 5,646,731; 5,614,365; 5,558,998; 5,538,850; 5,528,368; 5,514,596; 5,437,840; 5,405,747; 5,377,003; 5,329,461; 5,322,796; 4,979,824; 4,962,037; 7,067,644; 7,056,676;7,056,661; 7,056,659; 7,052,847; 7,049,074; 7,033,781; 7,033,764; 6,713,263; 6,610,256; 6,509,158; 6,485,625; 6,448,065; 6,448,012; 6,306,607; 6,296,810; 6,294,136; 6,246,046; 6,245,506; 6,236,945; 6,218,121; 6,150,089; 6,147,198; 6,017,434; 6,015,902; 6,001,566; 5,993,634; 5,968,784; 5,808,077; 5,720,928; 5,674,743; 5,624,845; 5,609,744; 20060057606; 20050255477; 20050227235; 20050208557; 20050202466; 20050186619; 20050164255; 20050158761; 20050155861; 20040077090; 20030124611; 20030092005; 20030044781; 20030036067; 20030027201; 20020173045; and 20020132349, incorporated herein by reference.

In certain embodiments, the detection system suitable for use in nucleic acid sequencing should be capable of detecting light from three, four, or five different sources—two color, three color and four color sequencing, where the additional color correspond to a donor color or to a marker color. The detection system can include up to one camera or detector per color. Thus, a two color sequencer could include one, two or three cameras or detectors; a three color sequencer could include one, two, three or four cameras or detectors; and a four color sequencer could include one, two, three, four or five cameras or detectors.

### Film Based Apparatus Embodiments

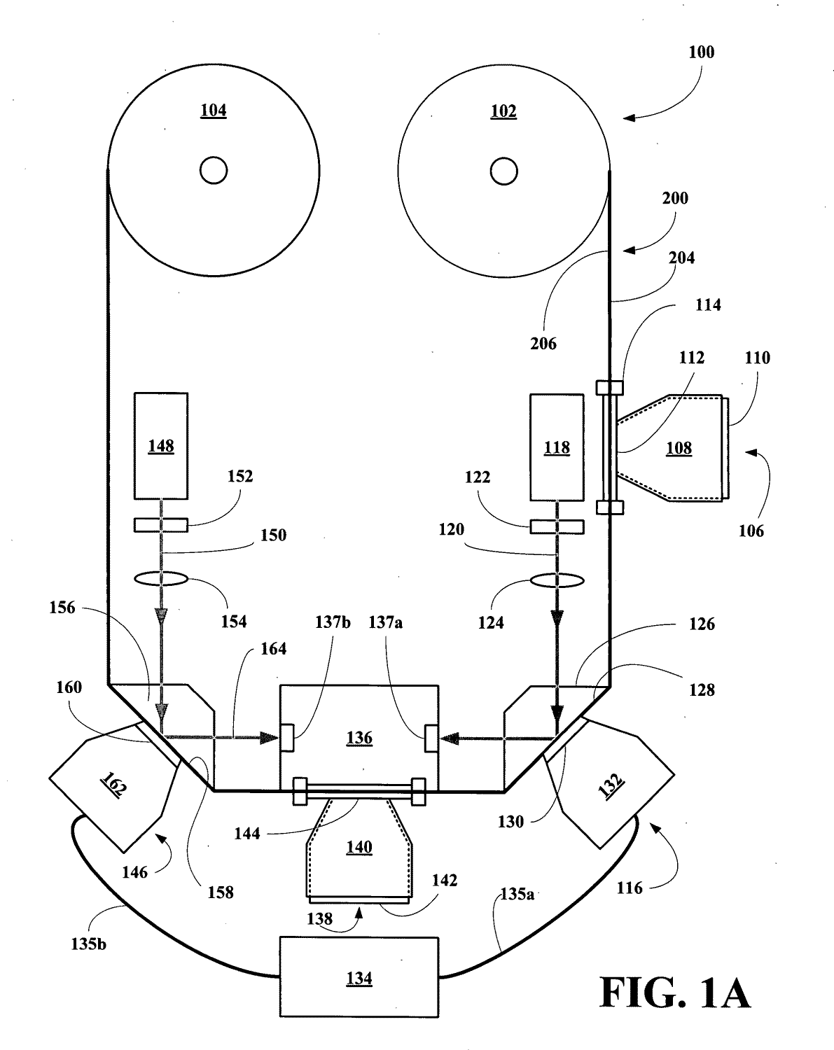

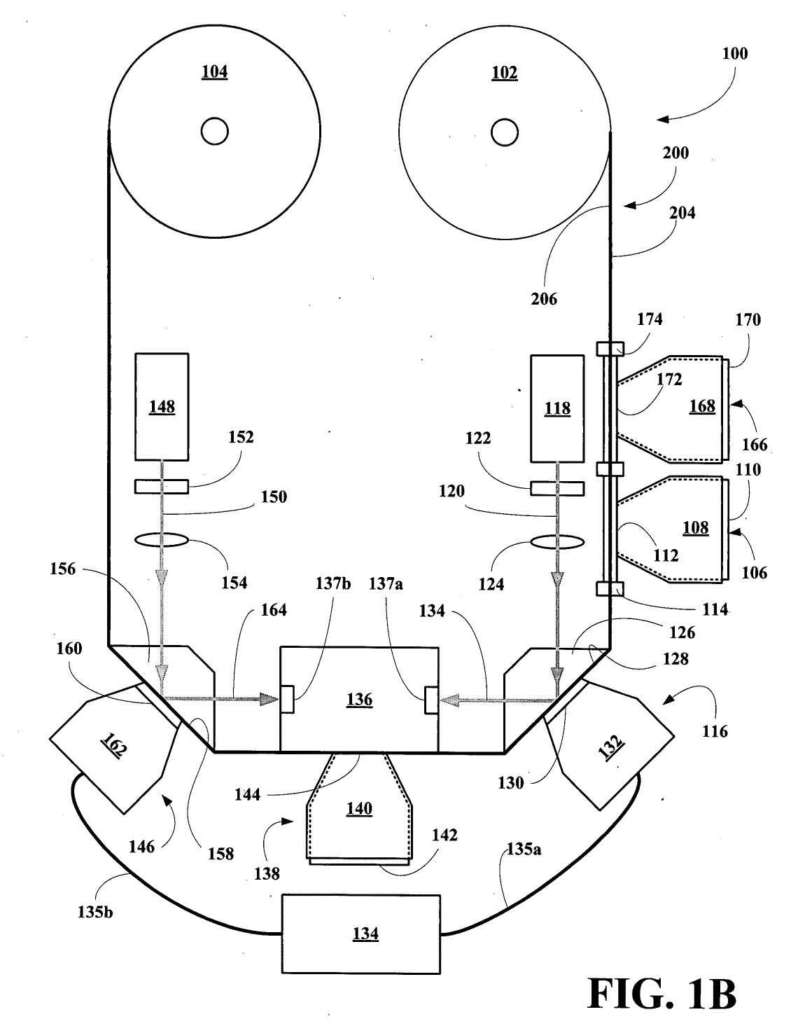

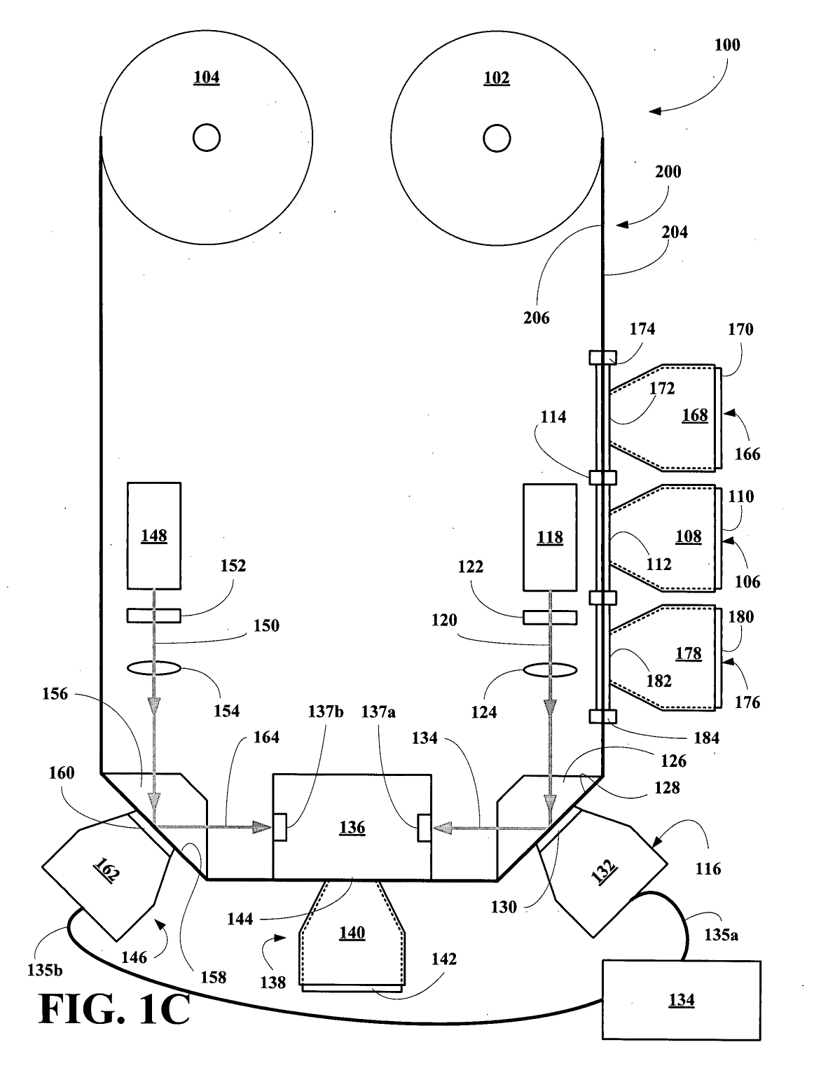

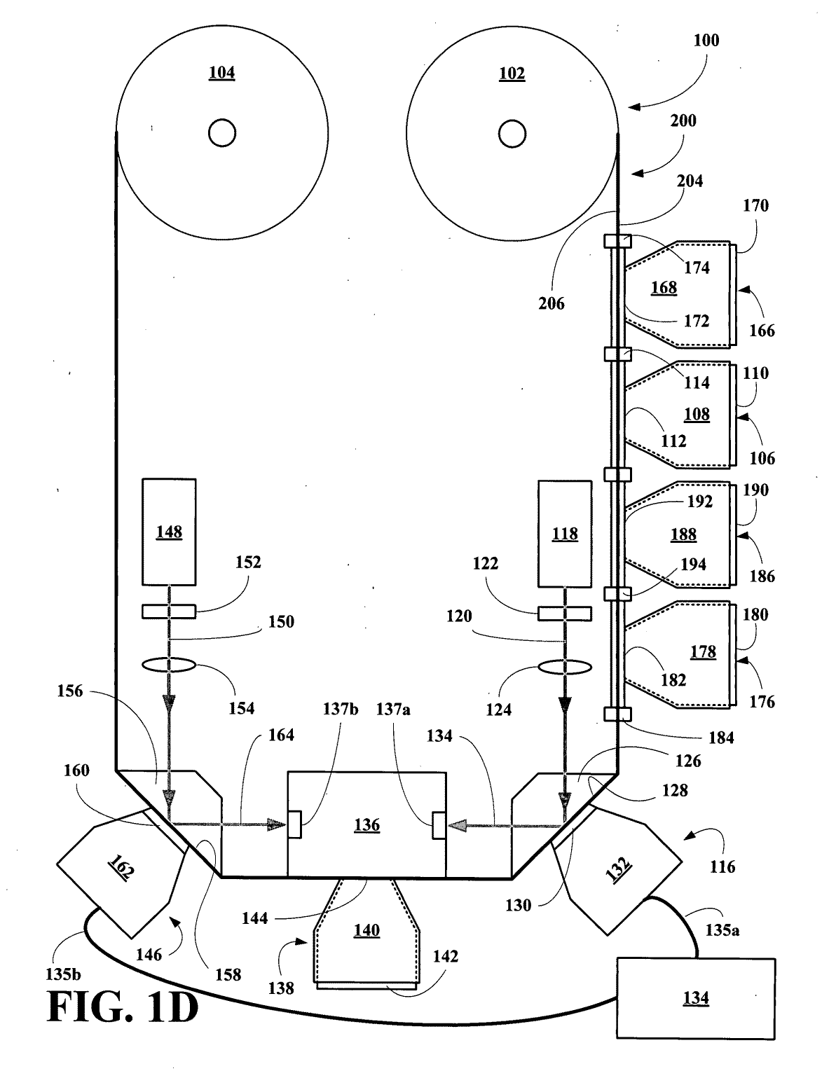

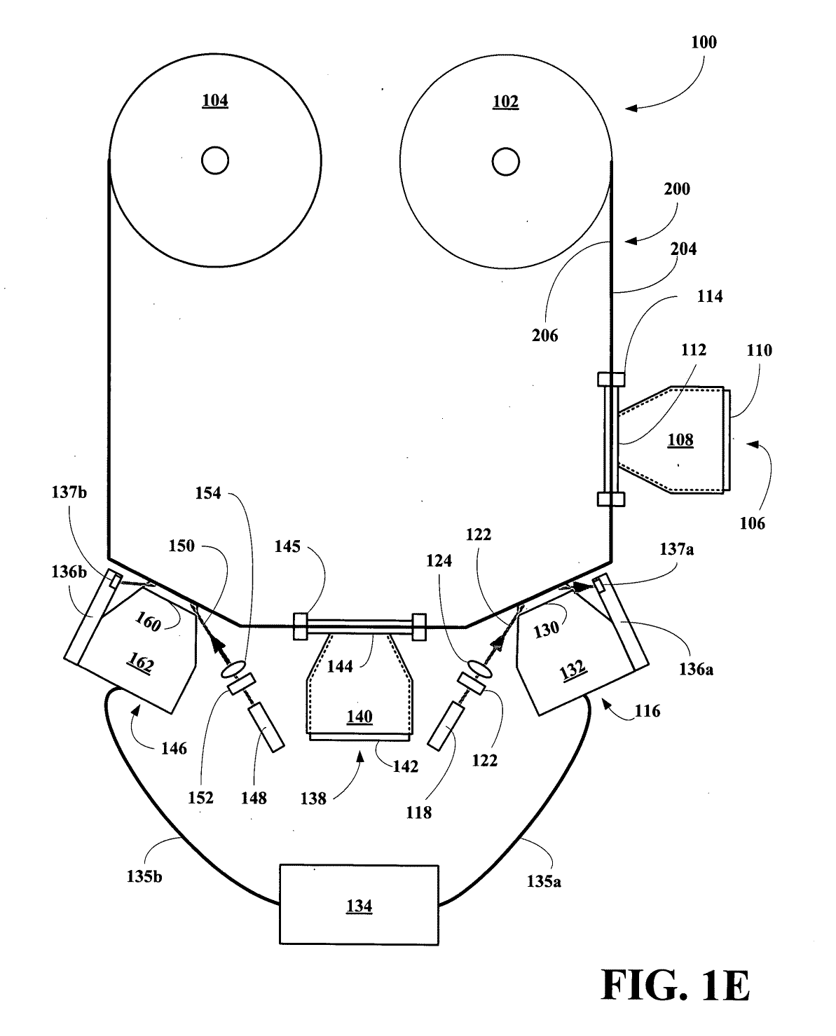

Referring now to FIG. 1A, an illustrative embodiment of an apparatus for monitoring single molecule or single molecular assemblage events of this invention, generally 100, is shown to include a let-out reel 102 and a take-up reel 104, where the let-out reel 102 unwinds a continuous film 200 and the take-up reel 104 takes up the continuous film 200 after the film 200 passes through stations of the apparatus. The film 200 includes a top side 204 and a bottom side 206, where the top side 204 have zones formed or disposed therein and/or thereon. It should be recognized that in the apparatus the film may be run with the top 204 up or the bottom 206 up depending on the design requirements of a particular apparatus of this invention.

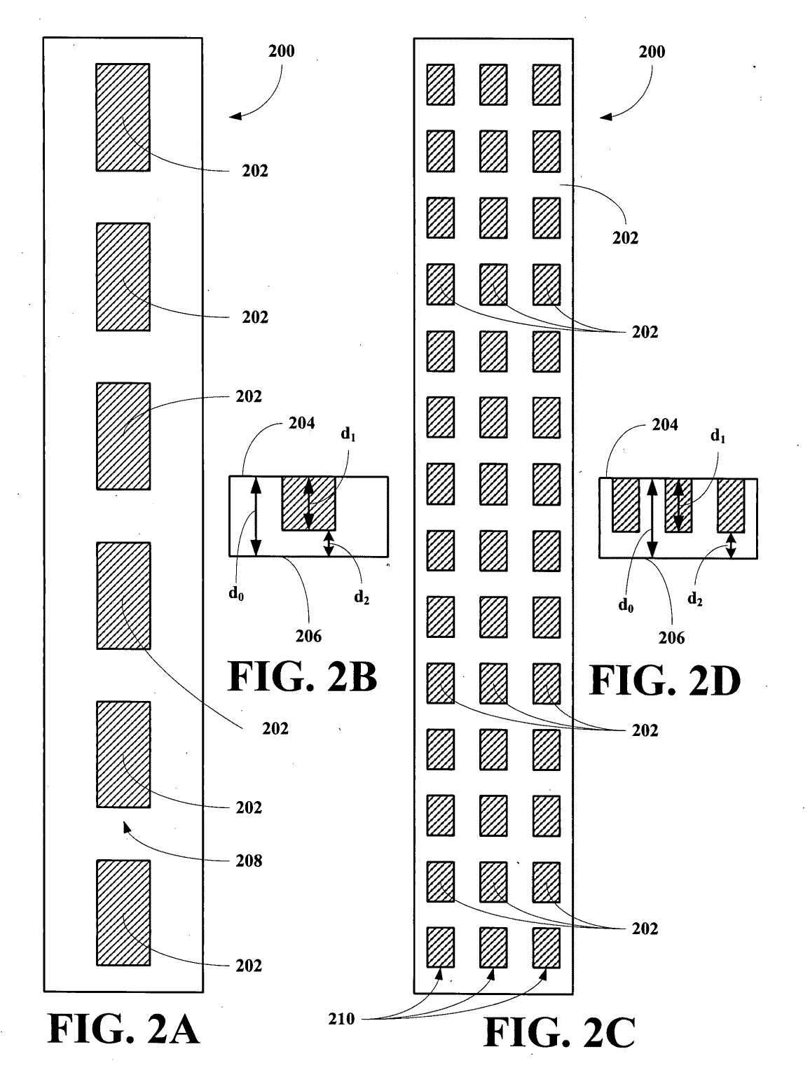

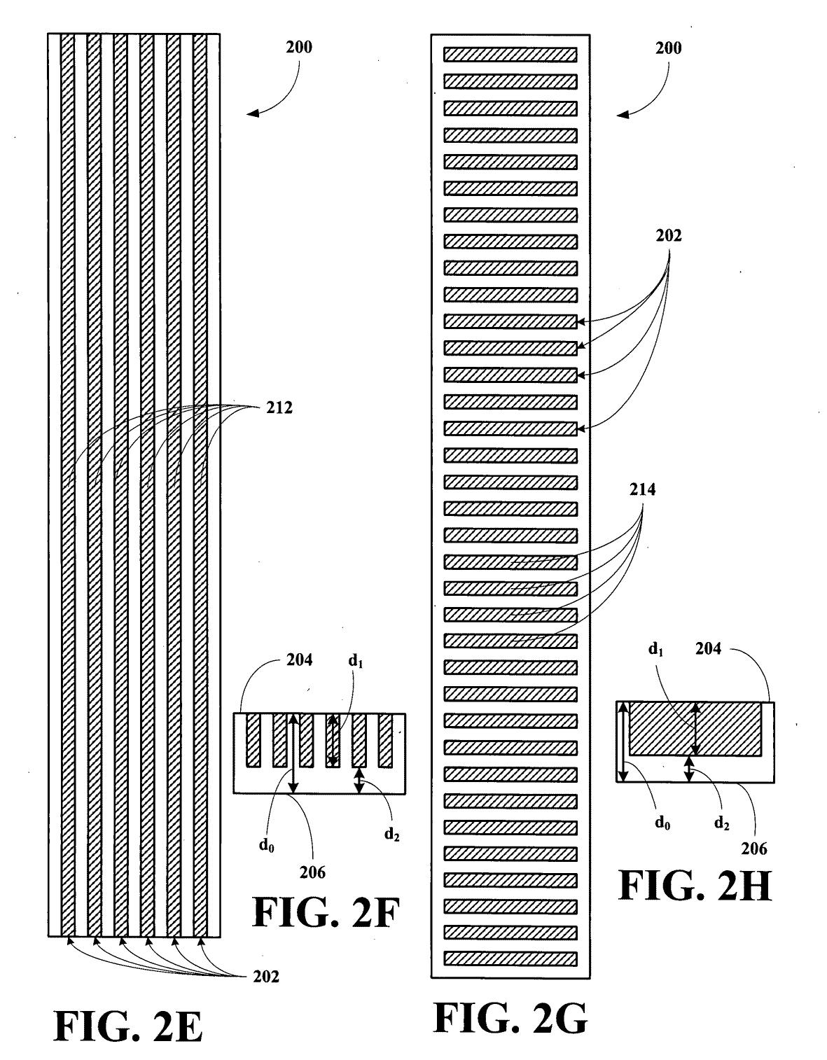

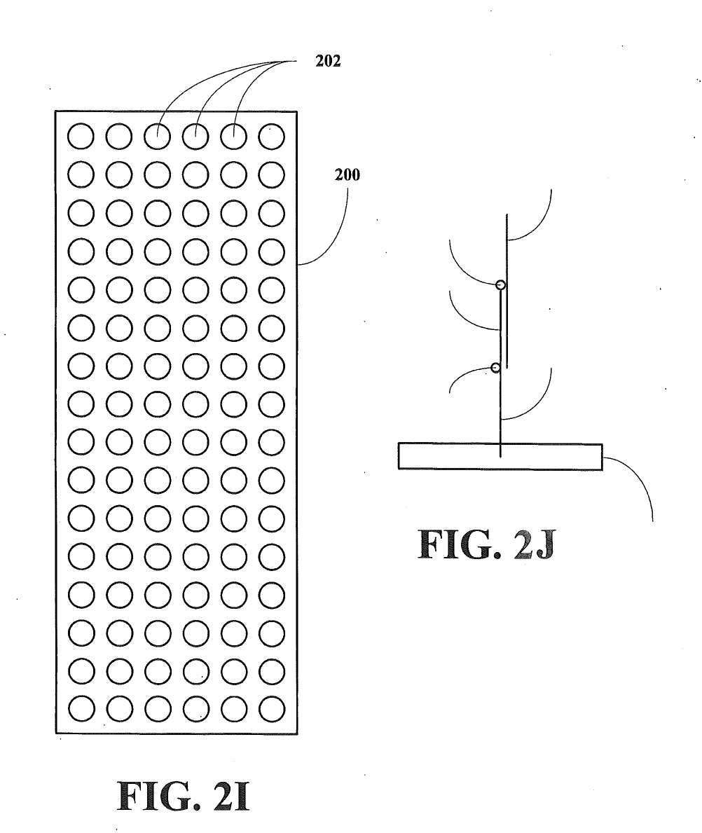

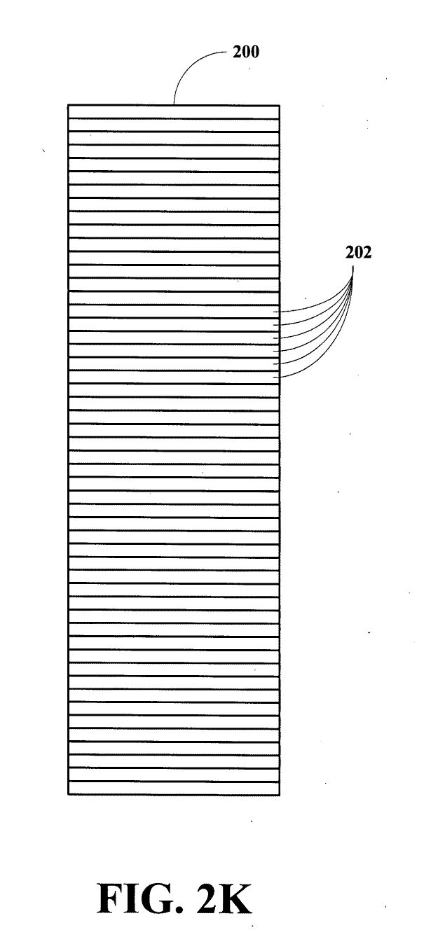

The apparatus 100 also includes a reagent station 106 including a reagent socket 108 adapted to receive a reagent cartridge 110, where the reagent socket 108 includes a reagent dispensing outlet or nozzle 112 adapted to allow one or a plurality of reagent from the reagent cartridge 110 to flow, to pump or to spray onto or into one zone or a plurality of zones 202 on the film 200 (see FIGS. 2A-H). The outlet 112 is held proximate the top or zone side 204 of the film 200 by a reagent station guide and socket holder 114.

After the reagent(s) has(have) been introduced onto or into the zone(s) 202, the continuous film 200 is advanced and passes through an optional single molecule or single molecular assemblage identifying or mapping station 116 including a light source 118 adapted to generate incident light beam 120 of a specific frequency range, a filter 122 adapted to narrow the frequency range of the incident light, and a lens 124 adapted to focus the light beam 120 onto the zone(s) 202 through a dove prism 126 having a long side 128 positioned proximate a back side 206 of the film 200. The dove prisms is adapted to deliver the incident light at the critical angle for TIRF at the substrate/aqueous interface such that only the fluorescent complexes will receive evanescent excitation energy. An alternative would be to use a through-the-lens system, thereby avoiding the need for prisms. It should be recognized by ordinary artisans that the light source can be designed without the filter 122 and/or the lens 124 depending on the type of light source used, e.g., a laser may not need the filter and/or lens, while a broad band light source would require the filter and lens. The incident light 120 impinges on the zone(s) 202 of the film 200 where it excites fluorescent tags associated with, in proximity to or bonded to all reactive single molecule sites within the zone(s) 202. Fluorescent light emitted by active sites in the zone(s) 202 passes through an objective lens 130 held proximate the zone side 204 of the film 200 by a detector 132, which detects an image of the fluorescent light emitted within a view field of the detector within the zone(s) 202. The detector 132 generates an output signal which is forwarded to an analyzer 134 via a cable 135a. The incident light beam 120 then passes out of the dove prism 126 into an absorption box 136 through a first light port 137a. The absorption box 136 is designed to absorb any incident light the is not absorbed to excited active sites in the zone(s) 202. The detector 132 and the analyzer 134 are adapted to detect and locate (identify) or map detectably discernible single molecule, single molecular or single molecular assemblage sites in the zone(s) 202.

After the passing through the optional identification or mapping station 116, the film 200 is advanced and passes through an initiation station 138 including an initiator socket 140 adapted to receive an initiator cartridge 142, where the initiator socket 140 includes an initiator dispensing outlet or nozzle 144 adapted to allow an initiator or a plurality of initiators from the initiator cartridge 142 to flow onto or into a zone(s) 202 on the film 200. The outlet 144 is held proximate the zone side 204 of the film 200 by the socket 140.

Next, the film 200 is advanced and passes through an event detection station 146 including a light source 148 adapted to generate incident light beam 150 of a specific frequency range, a filter 152 adapted to narrow the frequency range of the incident light, and a lens 154 adapted to focus the light beam 150 onto the zone(s) 202 through a dove prism 156 having a long side 158 positioned proximate a back side 206 of the film 200. It should be recognized by ordinary artisans that the light source can be designed without the filter 152 and/or the lens 154 depending on the type of light source used, e.g., a laser may not need the filter and/or lens, while a broad band light source would require the filter and lens. The incident light 150 impinges on the zone(s) 202 of the film 200 where it excites donor moieties associated with, in proximity to or bonded to all single molecule or single molecular sites within the zone(s) 202. The incident light 150 impinges on the zone(s) 202 of the film 200 where it excites fluorescent tags associated with, in proximity to or bonded to all reactive single molecule sites within the zone(s) 202. Fluorescent light emitted by active sites in the zone(s) 202 passes through an objective lens 160 held proximate the zone side 204 of the film 200 by a detector 162, which detects an image of the fluorescent light emitted within a view field of the detector within the zone(s) 202. The detector 132 generates an output signal which is forwarded to an analyzer 134 via a cable 135b. The incident light beam 150 then passes out of the dove prism 156 into an absorption box 136 through a second light port 137b. The absorption box 136 is designed to absorb any incident light the is not absorbed to excited active sites in the zone(s) 202. The detector 162 and the analyzer 134 are adapted to detect reaction events occurring at the detectably discernible single molecule, single molecular or single molecular assemblage sites previously identified or mapped in the zone(s) 202 within a given time period, the time the film 200 takes to advance past the event detection station 146. Then analyzed molecules may be stored on the take up roll 104.

In certain embodiment, the apparatus is set up in a TIRF. In this type of set up, the objective lens is generally separated from the zone(s) by an oil film of a desired index of refraction. The oil film is kept off the zone(s) by a transparent material interposed between the oil and the zone(s) or an inert gas film interposed between the objective and the zone(s).

Once the initiation reagents are added, the primers can have a photolysable 3′ blocking so that the reactions can be started after the detection system 146 has aligned and correlated the sites by exposing the zone or zones to light sufficient to deprotect the 3′ end of the primer and start sequencing.

Referring now to FIG. 1B, another embodiment of an apparatus for monitoring single molecule or single molecular assemblage events of this invention, generally 100, is shown to include a let-out reel 102 and a take-up reel 104, where the let-out reel 102 unwinds a continuous film 200 and the take-up reel 104 takes up the continuous film 200 after the film 200 passes through the various stations of the apparatus. The film 200 includes zones 202 disposed on or in a zone side 204 of the film 200 as described more fully below.

The film 200 advances to a buffer station 166 including a buffer socket 168 adapted to receive a buffer cartridge 170, where the buffer socket 168 includes a buffer dispensing outlet or nozzle 172 adapted to allow a buffer from the buffer cartridge 170 to flow, to be pumped or to be sprayed onto or into a zone(s) 202 on the film 200 to equilibrate the zone(s) 202 with the buffer. The outlet 172 is held proximate the zone side 204 of the film 200 by a buffer station film guide and socket holder 174.

After the buffer station 166, the film 200 is advanced to the sample station 106 including a sample socket 108 adapted to receive a sample cartridge 110, where the sample socket 108 includes a sample dispensing outlet or nozzle 112 adapted to allow a sample from the sample cartridge 110 to flow onto or into a zone or a plurality of zones 202 on the film 200. The outlet 112 is held proximate the zone side 204 of the film 200 by a sample station film guide and socket holder 114.

After the sample has been introduced onto or into the zone(s) 202, the continuous film 200 is advanced and may pass through a single molecule or single molecular assemblage identification or mapping station 116 including a light source 118 adapted to generate incident light beam 120 of a specific frequency range, a filter 122 adapted to narrow the frequency range of the incident light, and a lens 124 adapted to focus the light beam 120 onto the zone(s) 202 through a dove prism 126 having a long side 128 positioned proximate to a back side 206 of the film 200. It should be recognized by ordinary artisans that the light source can be designed without the filter 122 and/or the lens 124 depending on the type of light source used, e.g., a laser may not need the filter and/or lens, while a broad band light source would require the filter and lens. The incident light 120 impinges on the zone(s) 202 of the film 200 where it excites fluorescent tags associated with, in proximity to or bonded to all reactive single molecule sites within the zone(s) 202. Fluorescent light emitted by active sites in the zone(s) 202 passes through an objective lens 130 held proximate to the zone side 204 of the film 200 by a detector 132, which detects an image of the fluorescent light emitted within a view field of the detector within the zone(s) 202. The detector 132 generates an output signal which is forwarded to an analyzer 134 via a cable 135a. The incident light beam 120 then passes out of the dove prism 126 into an absorption box 136 through a first light port 137a. The absorption box 136 is designed to absorb any incident light the is not absorbed to excited active sites in the zone(s) 202. The detector 132 and the analyzer 134 are adapted to detect and locate (identify) or map detectably discernible single molecule, single molecular or single molecular assemblage sites in the zone(s) 202.

After the passing through the identification or mapping station 116, the film 200 is advanced and passes through an initiation station 138 including an initiator socket 140 adapted to receive an initiator cartridge 142, where the initiator socket 140 includes an initiator dispensing outlet or nozzle 144 adapted to allow an initiator from the initiator cartridge 142 to flow onto or into a zone(s) 202 on the film 200. The outlet 144 is held proximate to the zone side 204 of the film 200 by the socket 140.

Next, the film 200 is advanced and passes through an event detection station 146 including a light source 148 adapted to generate incident light beam 150 of a specific frequency range, a filter 152 adapted to narrow the frequency range of the incident light, and a lens 154 adapted to focus the light beam 150 onto the zone(s) 202 through a dove prism 156 having a long side 158 positioned proximate a back side 206 of the film 200. It should be recognized by ordinary artisans that the light source can be designed without the filter 152 and/or the lens 154 depending on the type of light source used, e.g., a laser may not need the filter and/or lens, while a broad band light source would require the filter and lens. The incident light 150 impinges on the zone(s) 202 of the film 200 where it excites donor moieties associated with, in proximity to or bonded to all single molecule or single molecular sites within the zone(s) 202. The incident light 150 impinges on the zone(s) 202 of the film 200 where it excites fluorescent tags associated with, in proximity to or bonded to all reactive single molecule sites within the zone(s) 202. Fluorescent light emitted by active sites in the zone(s) 202 passes through an objective lens 160 held proximate the zone side 204 of the film 200 by a detector 162, which detects an image of the fluorescent light emitted within a view field of the detector within the zone(s) 202. The detector 132 generates an output signal which is forwarded to an analyzer 134 via a cable 135b. The incident light beam 150 then passes out of the dove prism 156 into an absorption box 136 through a second light port 137b. The absorption box 136 is designed to absorb any incident light the is not absorbed to excited active sites in the zone(s) 202. The detector 162 and the analyzer 134 are adapted to detect reaction events occurring at the detectably discernible single molecule, single molecular or single molecular assemblage sites previously identified or mapped in the zone(s) 202 within a given time period, the time the film 200 takes to advance past the event detection station 146. Then analyzed molecules may be stored on the take up roll 104.

Referring now to FIG. 1C, another embodiment of an apparatus for monitoring single molecule or single molecular assemblage events of this invention, generally 100, is shown to include a let-out reel 102 and a take-up reel 104, where the let-out reel 102 unwinds a continuous film 200 and the take-up reel 104 takes up the continuous film 200 after the film 200 passes through the various stations of the apparatus. The film 200 includes zones 202 disposed on or in a zone side 204 of the film 200 as described more fully below.

The film 200 advances to a buffer station 166 including a buffer socket 168 adapted to receive a buffer cartridge 170, where the buffer socket 168 includes a buffer dispensing outlet or nozzle 172 adapted to allow a buffer from the buffer cartridge 170 to flow onto or into a zone(s) 202 on the film 200 to equilibrate the zone(s) 202 with the buffer. The outlet 172 is held proximate the zone side 204 of the film 200 by a buffer station film guide and socket holder 174.

After the buffer station 166, the film 200 is advanced to the sample station 106 including a sample socket 108 adapted to receive a sample cartridge 110, where the sample socket 108 includes a sample dispensing outlet or nozzle 112 adapted to allow a sample from the sample cartridge 110 to flow onto or into a zone or a plurality of zones 202 on the film 200. The outlet 112 is held proximate the zone side 204 of the film 200 by a sample station film guide and socket holder 114.

After the sample station 106, the film 200 advances to a wash station 176 including a wash socket 178 adapted to receive a wash cartridge 180, where the wash socket 178 includes a buffer dispensing nozzle 182 adapted to allow a wash solution from the wash cartridge 180 to flow onto or into a zone or a plurality of zones on the film 200 to remove or reduce unbound sample within the zone(s) 202. The outlet 182 is held proximate the zone side 204 of the film 200 by a sample station film guide and socket holder 184.

After the sample has been introduced onto or into the zone(s) 202 and washed, the continuous film 200 is advanced and passes through an optional single molecule or single molecular assemblage identification or mapping station 116 including a light source 118 adapted to generate incident light beam 120 of a specific frequency range, a filter 122 adapted to narrow the frequency range of the incident light, and a lens 124 adapted to focus the light beam 120 onto the zone(s) 202 through a dove prism 126 having a long side 128 positioned proximate a back side 206 of the film 200. It should be recognized by ordinary artisans that the light source can be designed without the filter 122 and/or the lens 124 depending on the type of light source used, e.g., a laser may not need the filter and/or lens, while a broad band light source would require the filter and lens. The incident light 120 impinges on the zone(s) 202 of the film 200 where it excites fluorescent tags associated with, in proximity to or bonded to all reactive single molecule sites within the zone(s) 202. Fluorescent light emitted by active sites in the zone(s) 202 passes through an objective lens 130 held proximate the zone side 204 of the film 200 by a detector 132, which detects an image of the fluorescent light emitted within a view field of the detector within the zone(s) 202. The detector 132 generates an output signal which is forwarded to an analyzer 134 via a cable 135a. The incident light beam 120 then passes out of the dove prism 126 into an absorption box 136 through a first light port 137a. The absorption box 136 is designed to absorb any incident light the is not absorbed to excited active sites in the zone(s) 202. The detector 132 and the analyzer 134 are adapted to detect and locate (identify) or map detectably discernible single molecule, single molecular or single molecular assemblage sites in the zone(s) 202.

After the passing through the identification or mapping station 116, the film 200 is advanced and passes through an initiation station 138 including an initiator socket 140 adapted to receive an initiator cartridge 142, where the initiator socket 140 includes an initiator dispensing outlet or nozzle 144 adapted to allow an initiator from the initiator cartridge 142 to flow onto or into a zone(s) 202 on the film 200. The outlet 144 is held proximate the zone side 204 of the film 200 by the socket 140.

Next, the film 200 is advanced and passes through an event detection station 146 including a light source 148 adapted to generate incident light beam 150 of a specific frequency range, a filter 152 adapted to narrow the frequency range of the incident light, and a lens 154 adapted to focus the light beam 150 onto the zone(s) 202 through a dove prism 156 having a long side 158 positioned proximate a back side 206 of the film 200. It should be recognized by ordinary artisans that the light source can be designed without the filter 152 and/or the lens 154 depending on the type of light source used, e.g., a laser may not need the filter and/or lens, while a broad band light source would require the filter and lens. The incident light 150 impinges on the zone(s) 202 of the film 200 where it excites donor moieties associated with, in proximity to or bonded to all single molecule or single molecular sites within the zone(s) 202. The incident light 150 impinges on the zone(s) 202 of the film 200 where it excites fluorescent tags associated with, in proximity to or bonded to all reactive single molecule sites within the zone(s) 202. Fluorescent light emitted by active sites in the zone(s) 202 passes through an objective lens 160 held proximate the zone side 204 of the film 200 by a detector 162, which detects an image of the fluorescent light emitted within a view field of the detector within the zone(s) 202. The detector 132 generates an output signal which is forwarded to an analyzer 134 via a cable 135b. The incident light beam 150 then passes out of the dove prism 156 into an absorption box 136 through a second light port 137b. The absorption box 136 is designed to absorb any incident light the is not absorbed to excited active sites in the zone(s) 202. The detector 162 and the analyzer 134 are adapted to detect reaction events occurring at the detectably discernible single molecule, single molecular or single molecular assemblage sites previously identified or mapped in the zone(s) 202 within a given time period, the time the film 200 takes to advance past the event detection station 146. Then analyzed molecules may be stored on the take up roll 104.

Referring now to FIG. 1D, another embodiment of an apparatus for monitoring single molecule or single molecular assemblage events of this invention, generally 100, is shown to include a let-out reel 102 and a take-up reel 104, where the let-out reel 102 unwinds a continuous film 200 and the take-up reel 104 takes up the continuous film 200 after the film 200 passes through the various stations of the apparatus. The film 200 includes zones 202 disposed on or in a zone side 204 of the film 200 as described more fully below.

The film 200 advances to a buffer station 166 including a buffer socket 168 adapted to receive a buffer cartridge 170, where the buffer socket 168 includes a buffer dispensing outlet or nozzle 172 adapted to allow a buffer from the buffer cartridge 170 to flow onto or into a zone(s) 202 on the film 200 to equilibrate the zone(s) 202 with the buffer. The outlet 172 is held proximate the zone side 204 of the film 200 by a buffer station film guide and socket holder 174.

After the buffer station 166, the film 200 is advanced to the sample station 106 including a sample socket 108 adapted to receive a sample cartridge 110, where the sample socket 108 includes a sample dispensing outlet or nozzle 112 adapted to allow a sample from the sample cartridge 110 to flow onto or into a zone or a plurality of zones 202 on the film 200. The outlet 112 is held proximate the zone side 204 of the film 200 by a sample station film guide and socket holder 114.

The apparatus 100 also includes a reacting agent station 186 including a reacting agent socket 188 adapted to receive a reacting agent cartridge 190, where the reacting agent socket 188 includes a reacting agent dispensing nozzle 192 adapted to allow a reacting agent from the reacting agent cartridge 190 to flow onto or into a zone(s) 202 on the film 200. The outlet 192 is held proximate the zone side 204 of the film 200 by a reacting agent station film guide and socket holder 194. It should be recognized by an ordinary artisan that the apparatus 100 can include additional sample stations and reacting agent stations and that their order (which comes first) is only dependent on the exact reaction to which the apparatus 100 is to be used. For example, in nucleic acid sequencing where the zones have bound therein a template or a primer, the sample would comprise a primer or a template (to form a bound duplex) and the reacting agent would comprise a polymerizing agent such as a polymerase or a transcriptase (naturally occurring or man-made).

After the reacting agent station 186, the film 200 advances to a wash station 176 including a wash socket 178 adapted to receive a wash cartridge 180, where the wash socket 178 includes a buffer dispensing nozzle 182 adapted to allow a wash solution from the wash cartridge 180 to flow onto or into a zone or a plurality of zones on the film 200 to remove or reduce unbound sample within the zone(s) 202. The outlet 182 is held proximate the zone side 204 of the film 200 by a sample station film guide and socket holder 184.

After the sample and reagents have been introduced onto or into the zone(s) 202 and washed, the continuous film 200 is advanced and passes through an optional single molecule or single molecular assemblage identification or mapping station 116 including a light source 118 adapted to generate incident light beam 120 of a specific frequency range, a filter 122 adapted to narrow the frequency range of the incident light, and a lens 124 adapted to focus the light beam 120 onto the zone(s) 202 through a dove prism 126 having a long side 128 positioned proximate a back side 206 of the film 200. It should be recognized by ordinary artisans that the light source can be designed without the filter 122 and/or the lens 124 depending on the type of light source used, e.g., a laser may not need the filter and/or lens, while a broad band light source would require the filter and lens. The incident light 120 impinges on the zone(s) 202 of the film 200 where it excites fluorescent tags associated with, in proximity to or bonded to all reactive single molecule sites within the zone(s) 202. Fluorescent light emitted by active sites in the zone(s) 202 passes through an objective lens 130 held proximate the zone side 204 of the film 200 by a detector 132, which detects an image of the fluorescent light emitted within a view field of the detector within the zone(s) 202. The detector 132 generates an output signal which is forwarded to an analyzer 134 via a cable 135a. The incident light beam 120 then passes out of the dove prism 126 into an absorption box 136 through a first light port 137a. The absorption box 136 is designed to absorb any incident light the is not absorbed to excited active sites in the zone(s) 202. The detector 132 and the analyzer 134 are adapted to detect and locate (identify) or map detectably discernible single molecule, single molecular or single molecular assemblage sites in the zone(s) 202.

After the passing through the identification or mapping station 116, the film 200 is advanced and passes through an initiation station 138 including an initiator socket 140 adapted to receive an initiator cartridge 142, where the initiator socket 140 includes an initiator dispensing outlet or nozzle 144 adapted to allow an initiator from the initiator cartridge 142 to flow onto or into a zone(s) 202 on the film 200. The outlet 144 is held proximate the zone side 204 of the film 200 by the socket 140.

Next, the film 200 is advanced and passes through an event detection station 146 including a light source 148 adapted to generate incident light beam 150 of a specific frequency range, a filter 152 adapted to narrow the frequency range of the incident light, and a lens 154 adapted to focus the light beam 150 onto the zone(s) 202 through a dove prism 156 having a long side 158 positioned proximate a back side 206 of the film 200. It should be recognized by ordinary artisans that the light source can be designed without the filter 152 and/or the lens 154 depending on the type of light source used, e.g., a laser may not need the filter and/or lens, while a broad band light source would require the filter and lens. The incident light 150 impinges on the zone(s) 202 of the film 200 where it excites donor moieties associated with, in proximity to or bonded to all single molecule or single molecular sites within the zone(s) 202. The incident light 150 impinges on the zone(s) 202 of the film 200 where it excites fluorescent tags associated with, in proximity to or bonded to all reactive single molecule sites within the zone(s) 202. Fluorescent light emitted by active sites in the zone(s) 202 passes through an objective lens 160 held proximate the zone side 204 of the film 200 by a detector 162, which detects an image of the fluorescent light emitted within a view field of the detector within the zone(s) 202. The detector 132 generates an output signal which is forwarded to an analyzer 134 via a cable 135b. The incident light beam 150 then passes out of the dove prism 156 into an absorption box 136 through a second light port 137b. The absorption box 136 is designed to absorb any incident light the is not absorbed to excited active sites in the zone(s) 202. The detector 162 and the analyzer 134 are adapted to detect reaction events occurring at the detectably discernible single molecule, single molecular or single molecular assemblage sites previously identified or mapped in the zone(s) 202 within a given time period, the time the film 200 takes to advance past the event detection station 146. Then analyzed molecules may be stored on the take up roll 104.

Referring now to FIG. 1E, an illustrative embodiment of an apparatus for monitoring single molecule or single molecular assemblage events of this invention, generally 100, is shown to include a let-out reel 102 and a take-up reel 104, where the let-out reel 102 unwinds a continuous film 200 and the take-up reel 104 takes up the continuous film 200 after the film 200 passes through stations of the apparatus. The film 200 includes a top side 204 and a bottom side 206, where the top side 204 have zones formed or disposed therein and/or thereon. It should be recognized that in the apparatus the film may be run with the top 204 up or the bottom 206 up depending on the design requirements of a particular apparatus of this invention.

The apparatus 100 also includes a reagent station 106 including a reagent socket 108 adapted to receive a reagent cartridge 110, where the reagent socket 108 includes a reagent dispensing outlet or nozzle 112 adapted to allow one or a plurality of reagent from the reagent cartridge 110 to flow, to pump or to spray onto or into one zone or a plurality of zones 202 on the film 200 (see FIGS. 2A-H). The outlet 112 is held proximate the top or zone side 204 of the film 200 by a reagent station guide and socket holder 114.

After the reagent(s) has(have) been introduced onto or into the zone(s) 202, the continuous film 200 is advanced and passes through an optional single molecule or single molecular assemblage identifying or mapping station 116 including a light source 118 adapted to generate incident light beam 120 of a specific frequency range, a filter 122 adapted to narrow the frequency range of the incident light, and a lens 124 adapted to focus the light beam 120 onto the zone(s) 202 through an objective lens 130. The optics are adapted to deliver the incident light at the critical angle for TIRF at the substrate/aqueous interface such that only the fluorescent complexes will receive evanescent excitation energy. It should be recognized by ordinary artisans that the light source can be designed without the filter 122 and/or the lens 124 depending on the type of light source used, e.g., a laser may not need the filter and/or lens, while a broad band light source would require the filter and lens. The incident light 120 impinges on the zone(s) 202 of the film 200 where it excites fluorescent tags associated with, in proximity to or bonded to all reactive single molecule sites within the zone(s) 202. Fluorescent light emitted by active sites in the zone(s) 202 passes through an objective lens 128 held proximate the zone side 204 of the film 200 by a detector 130, which detects an image of the fluorescent light emitted within a view field of the detector within the zone(s) 202. The detector 132 generates an output signal which is forwarded to an analyzer 132 via a cable 135a. The incident light beam 120 then passes out of the objective 130 into an absorption box 134a through a first light port 137a. The absorption box 136a is designed to absorb any incident light the is not absorbed to excited active sites in the zone(s) 202. The detector 132 and the analyzer 134 are adapted to detect and locate (identify) or map detectably discernible single molecule, single molecular or single molecular assemblage sites in the zone(s) 202. Again, the light beam 122 is designed to impinge on the zone 202 at the critical TIRF angle.

After the passing through the optional identification or mapping station 116, the film 200 is advanced and passes through an initiation station 136 including an initiator socket 138 adapted to receive an initiator cartridge 140, where the initiator socket 140 includes an initiator dispensing outlet or nozzle 142 adapted to allow an initiator or a plurality of initiators from the initiator cartridge 142 to flow onto or into a zone(s) 202 on the film 200. The outlet 144 is held proximate the zone side 204 of the film 200 by the socket 140 via a holder 145.

Next, the film 200 is advanced and passes through an event detection station 146 including a light source 148 adapted to generate incident light beam 150 of a specific frequency range, a filter 152 adapted to narrow the frequency range of the incident light, and a lens 154 adapted to focus the light beam 150 onto the zone(s) 202 through an objective 160 at the critical TIRF angle. It should be recognized by ordinary artisans that the light source can be designed without the filter 152 and/or the lens 154 depending on the type of light source used, e.g., a laser may not need the filter and/or lens, while a broad band light source would require the filter and lens. The incident light 150 impinges on the zone(s) 202 of the film 200 where it excites donor moieties associated with, in proximity to or bonded to all single molecule or single molecular sites within the zone(s) 202. The incident light 150 impinges on the zone(s) 202 of the film 200 where it excites fluorescent tags associated with, in proximity to or bonded to all reactive single molecule sites within the zone(s) 202. Fluorescent light emitted by active sites in the zone(s) 202 passes through the objective lens 160 held proximate the zone side 204 of the film 200 by a detector 162, which detects an image of the fluorescent light emitted within a view field of the detector within the zone(s) 202. The detector 162 generates an output signal which is forwarded to an analyzer 134 via a cable 135b. The incident light beam 150 then passes out of the station 146 into an absorption box 136b through a second light port 137b. The absorption box 136b is designed to absorb any incident light the is not absorbed to excited active sites in the zone(s) 202. The detector 162 and the analyzer 134 are adapted to detect and analyze reaction events occurring at the detectably discernible single molecule, single molecular or single molecular assemblage sites previously identified or mapped in the zone(s) 202 within a given time period, the time the film 200 takes to advance past the event detection station 146. Then analyzed molecules may be stored on the take up roll 104.

In certain embodiment, the apparatus is set up in a TIRF. In this type of set up, the objective lens is generally separated from the zone(s) by an oil film of a desired index of refraction. The oil film is kept off the zone(s) by a transparent material interposed between the oil and the zone(s) or an inert gas film interposed between the objective and the zone(s).

Once the initiation reagents are added, the primers can have a photolysable 3′ blocking so that the reactions can be started after the detection system 146 has aligned and correlated the sites by exposing the zone or zones to light sufficient to deprotect the 3′ end of the primer and start sequencing.

It should be recognized by one skilled in the art that the number of stations can be increased or decreased depending on the specific application to which the apparatus is being used. But the apparatus of FIG. 1A is a minimal configuration for tape type embodiments of this invention.

The light beam does not enter the solution. The dove prism adjusts the path of the beam such that it strikes the substrate-aqueous interface at the critical angle for total internal reflection. The incident beam is reflected at the substrate-aqueous interface, and the reaction complexes bound to the substrate are excited by evanescent energy generated by the reflected incident light. In this way, only fluorophores located within ˜50 nm of the substrate-aqueous interface are excited. Fluorescent events, which occur only within the region of the zone, are then detected by the detector associated with the detection stations.

As an alternative embodiment, we will use a through-the-lens TIRF system in which the laser excitation energy is delivered through the objective lens located on the opposite (inert) side of the substrate (where the dove prisms are located in FIG. 1A-E) and at the critical angle for total internal reflection at the substrate-aqueous interface. This embodiment is preferred for some applications, because it limits excitation to the field of view of the lens.

In either case, the objective lens projects an image of the distribution of reaction complexes onto a cooled CCD or iCCD chip that is incorporated into a digital camera. This imaging system measures the fluorescence intensity at each pixel onto which the light from an individual reaction complex is projected (as determined at the mapping station).

The light path and detection events are now described. Laser light is directed to prism at an adjustable angle. The refracted beam then passes through the surface of the long side of the prism. Next, the beam passes through an oil film having a refractive index that matches the refractive index of the substrate. The beam, then, passes through the substrate and encounters the substrate-aqueous interface at a critical angle adapted to support total internal reflection of incident light (reflected beam is directed to a photodiode for intensity determination). The beam results in the generation of an evanescent wave that excites fluors associated with the complexes bound to the substrate. The excited fluors then emit photons some of which pass through the solution, across the quartz window, through the oil film and the front glass of the objective lens. These photons are then collected by the objective lens and an image of the reactive surface is projected onto a detector such as a CCD or iCCD camera, or a cooled CCD camera or iCCD camera.

This image is compared with the image of the distribution of single reaction sites detected at the mapping station, and only those pixels detect light from regions of the substrate that we determined to contain single reaction sites (at the mapping station) are used for data (sequence) analysis.

### Film Configurations

Referring now to FIGS. 2A-H, several embodiments of continuous films of this invention, generally 200, are shown. Looking at FIGS. 2A-B, a continuous film 200 having a thickness d₀ and including a plurality of spaced apart zones 202 disposed on a zone side 204 and having a depth d₁, while maintaining a sufficient remaining film thickness d₂ measured from a film back side 206. The zones 202 of this embodiment are disposed in a middle 208 of the film 200.

Looking at FIGS. 2C-D, a first continuous film 200 having a thickness d₀ and including three parallel disposed rows 210, each row 210 includes a plurality of spaced apart zones 202 disposed on a zone side 204 and having a depth d₁, while maintaining a sufficient remaining film thickness d₂ measured from a film back side 206. The zones 202 of this embodiment are disposed in a middle 208 of the film 200. Although the zones are shown as rectangular, the shape is not meant as a limitation as the zones can be any shape including, without limitation, circular, elliptical, triangular, polygonal, or any other shape one would desire, being a design preference and not a limitation preference.

Looking at FIGS. 2E-F, a continuous film 200 having a thickness d₀ and including a plurality zones 202 comprising parallel disposed, continuous bands 212, each band 212 is disposed on a zone side 204 and having a depth d₁, while maintaining a sufficient remaining film thickness d₂ measured from a film back side 206. The zones 202 of this embodiment are disposed in a middle 208 of the film 200. Of course, one of ordinary skill can recognize that the number of parallel bands 212 can be any number limited only by the width of the film and the size and spacing between the bands 212. Thus, the bands 212 could represent channels of a molecular dimension which can be prepared using modern chip photolithographic techniques.

Looking at FIGS. 2G-H, a continuous film 200 having a thickness d₀ and including a plurality zones 202 comprising transversely disposed bands 214, each band 214 is disposed on a zone side 204 and having a depth d₁, while maintaining a sufficient remaining film thickness d₂ measured from a film back side 206. The zones 202 of this embodiment are disposed in a middle 208 of the film 200.

In certain embodiments, as shown in FIG. 21, the zones 202 are circular and are the same size as the field of view of the detector. In one configuration, the tape 200 includes six zones 202 across the tape. The apparatus 100 is adapted to move at controlled rate. In certain embodiments, the rate for aligning a new viewing field can be between about 1 second and about 10 minutes, depending on the nature of the system being analyzes. The field is mapped by photobleaching with 488 nm laser. Primers are activated with a flash from a near UV laser to begin the reaction. This is accomplished by fixing the primer/templated duplex to the surface of the reaction zones 202. The primer includes a 5′ marker fluorophore for chip interrogation and a photolysable 3′ blocking group. The reaction is started when a new zone moves into position by a flash of light designed to photocleave the 3′ photolysable blocking group on the primer.

Looking at FIG. 2J, a continuous film 200 is shown to comprise a diffraction grating forming the zones 202 with spacing of about 340 nm. The grating is designed so that linearly polarized 488 nm light is totally reflected from the surface eliminating the need for a prism, i.e., TIRF without a prism. Similarly, linearly polarized 340 nm light will pass the grating. The grating can also be constructed to be an acouto-optical polarizing filter to change from un-polarized and linearly polarized light.

Although several film configuration have been described above, it should be clear to ordinary artisans that other zone configurations can be inscribed in the surface of a continuous film provided that the zones are capable of binding reagents within the zones and capable of passing through the stations of the apparatus so that buffers, samples, reacting agents and initiators can be added to the zones and so that light can be used to map detectably discernible reactive molecular sites and can be used to detect reaction events occurring at the mapped sites.

### Expanded Views of the Mapping and Event Detection Stations

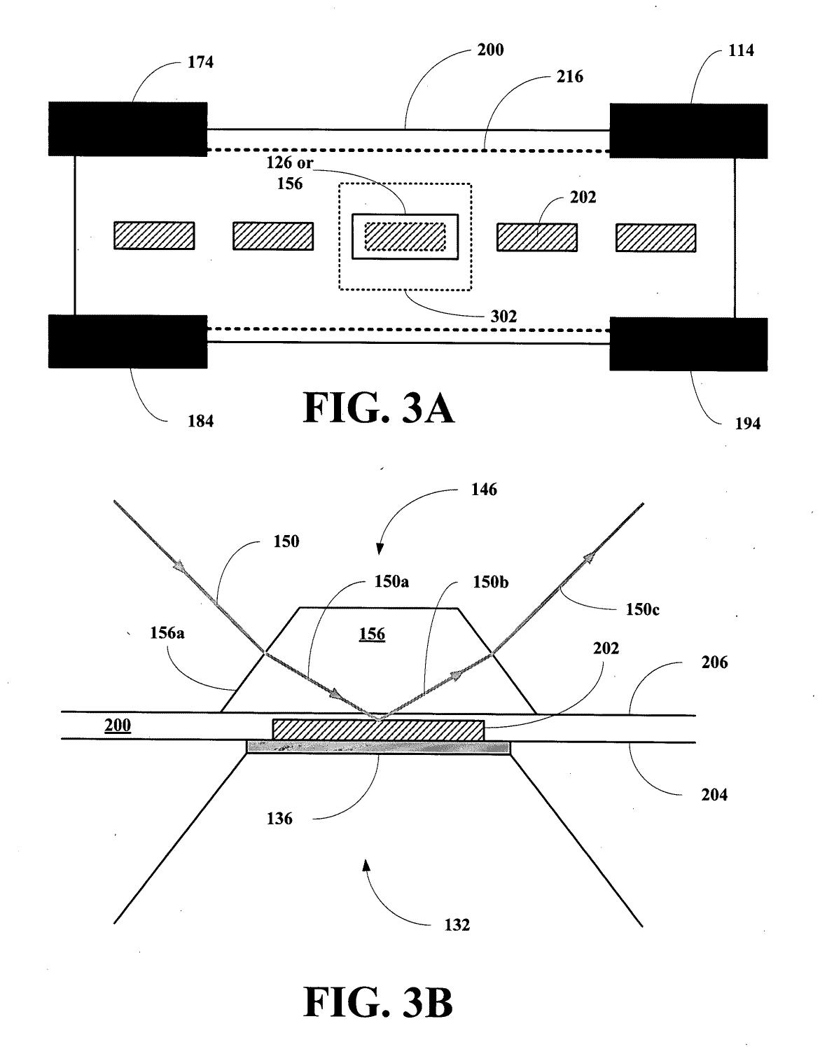

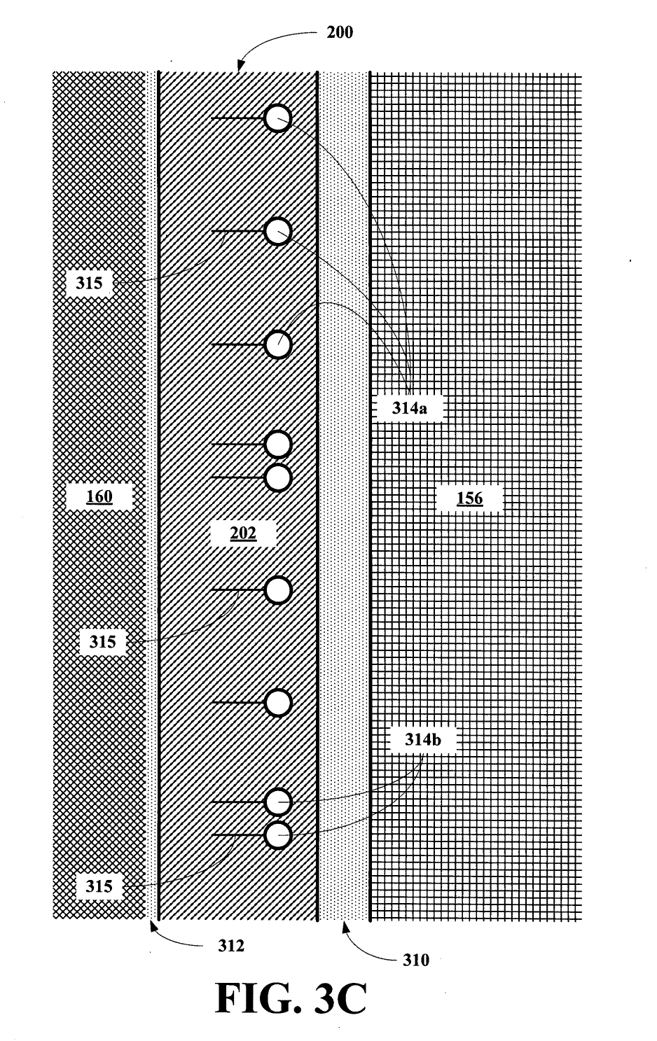

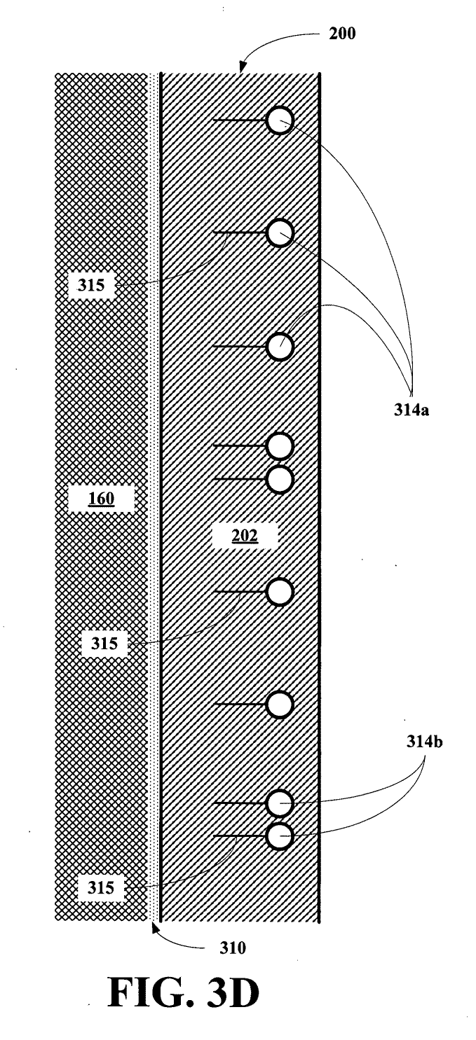

Referring now to FIG. 3A, an expanded view of the film 200 as it passing through the stations described above. The film 200 is shown having zones 202 and edge track perforations 216 which are adapted to engage the guides 114, 174, 184 and 194 and guides associated with the other stations, which is part of the construction of the stations 116 and 146. The guides can be simple free rotating wheels or other devices to keep the film within design criteria. Also shown in FIG. 3A are common elements of either the mapping or detection station 116 or 146. Thus, either the dove prism 126 or 156 is shown positioned on the zone side 204 over the zone 202. Surrounding the prism 126 or 156, an optional vacuum manifold 302 adapted to hold the tape or film against the prism 126 or 156 to improve mapping or detection efficiency.

Referring now to FIG. 3B, the operation of the detection station 146 is illustrated. Note that by simply changing the direction of the arrows on the light beam, FIG. 3B would illustrate the mapping station 116. The light beam 150, which entered the prism 156 at its left side face 156a, undergoes a change in direction due to the difference in refractive index forming internal beam 150a, which is directed at a portion of the back side 206 of the tape opposite the zone 202. The back side portion changes as the zone 202 advances past the detection station. Of course, the apparatus 100 can be operated with automatic holds so that a single location within a zone 202 can be irradiated and detected for a longer period of time. The light beam 150a then penetrates the tape and interacts with molecular sites within the zone 202 causing either direct fluorescence of the donor or acceptor or FRET between a donor and acceptor pair. A portion of the incident light and a portion of the fluorescent light then combine to form a second internal beam 150b, which exits the prism 156 at its right side face 156d to form an exiting light beam 150c. The exiting light beam 150c is then forwarded to the detector 132 or 162 (see FIGS. 1A-D). In the detectors, the intensity of incident light and/or fluorescent light are detected. In embodiments involving FRET as the sequencing format, isolated single molecule or molecular sites within each detected zone are determined in the mapping station 116, because the sites only include donor fluorescence. In the event detection station, fluorescent light directly from the donor and from the acceptor(s) via FRET are analyzed and polymerization events or reaction events are determined at the detectably discernible sites. The zone 202 is placed in contact with the mirrored objective lens, where the contacting can be direct or through a cover with an microscope oil film interposed therebetween.

Referring now to FIG. 3C, an expanded view of the film as it passing through the detection station 146 (applies equally well to station 116) of FIGS. 1A-D described above is shown. A zone 202 of the substrate 200 is shown sandwiched between the prism 156 and the objective lens 160. An oil film 310 is situated between the substrate 200 and the prism 156 to reduce refraction of the incident light. The oil film 310 is an optical oil having the same refractive index as the substrate 200. An optional second oil film 312 may also be interposed between the objective 160 and the substrate to reduce light refraction. The light beam (not shown) is entering from the right through the prism 156 at the critical angle for total internal reflection. The zone 202 includes bound molecular assemblages 314. The assemblages 314a represent assemblages that would give rise to individually discernible detection events, while the assemblages 314b represent sites that would not lead to individually discernible detection events because two or more assemblages are located too close to each other. The tails 315 extending from the assemblages 314 represent growing product resulting from the incorporation reactions occurring within the zone. These sites with multiple donor emissions would be rejected as suitable sites during the mapping process.

Referring now to FIG. 3D, an expanded view of the film as it passing through the detection station 146 (applies equally well to station 116) of FIG. 1E described above is shown. A zone 202 of the substrate 200 is shown situated adjacent the objective lens 160. An oil film 310 is situated between the substrate 200 and the objective 160 to reduce refraction of the incident light. The oil film 310 is an optical oil having the same refractive index as the substrate 200. The light beam (not shown) is entering from the left through the objective 160 at the critical angle for total internal reflection. The zone 202 includes bound molecular assemblages 314. The assemblages 314a represent assemblages that would give rise to individually discernible detection events, while the assemblages 314b represent sites that would not lead to individually discernible detection events because two or more assemblages are located too close to each other. The tails 315 extending from the assemblages 314 represent growing product resulting from the incorporation reactions occurring within the zone. These sites with multiple donor emissions would be rejected as suitable sites during the mapping process.

### Rigid Substrate Based Apparatus Embodiments

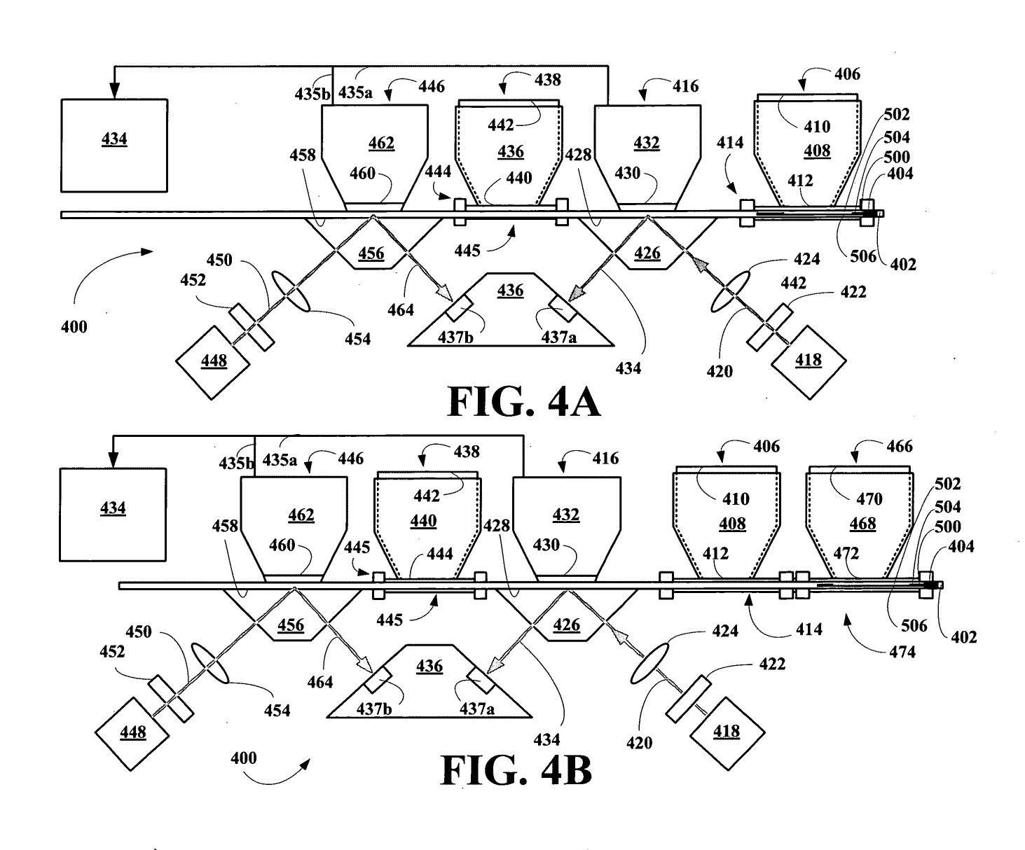

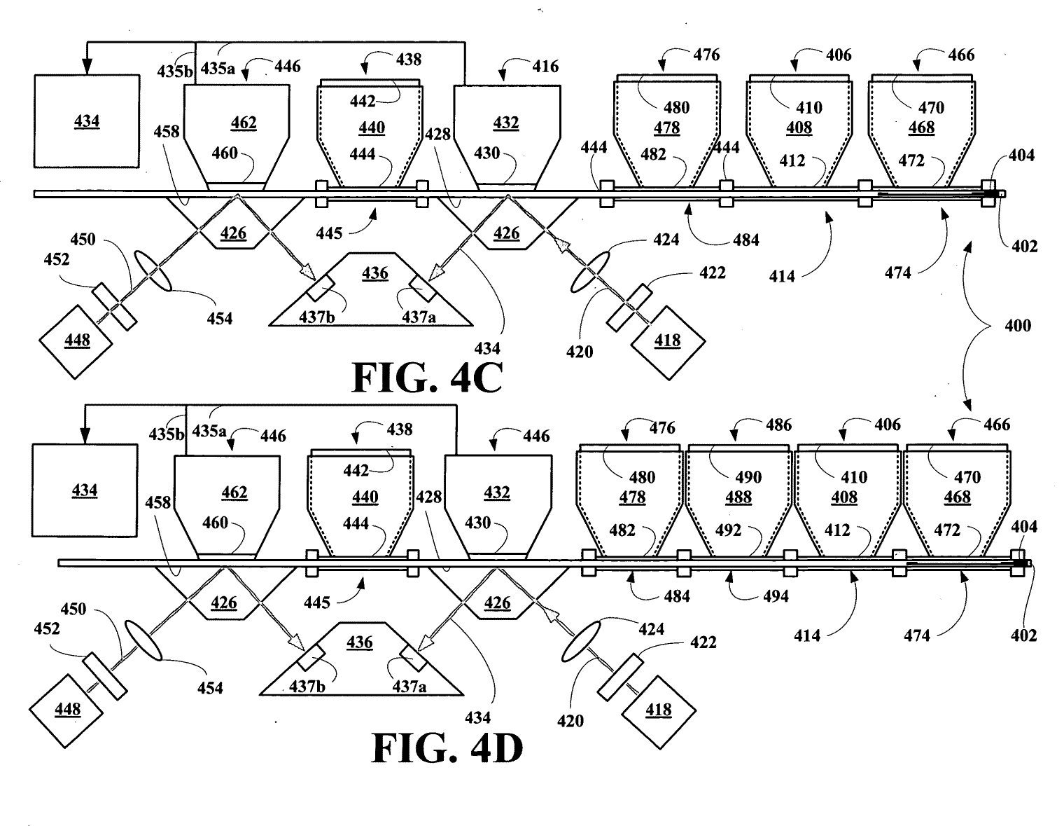

Referring now to FIG. 4A, an embodiment of an apparatus for monitoring single molecule or single molecular assemblage events of this invention, generally 400, is shown to include a guide slot 402 and a drive bar 404. The drive bar 404 is adapted to move a rigid substrate 500 through the slot 402 past each of a plurality of stations of the apparatus 400. The substrate 500 includes a top side 504 and a bottom side 506, where the top side 504 have zones formed or disposed therein or thereon.

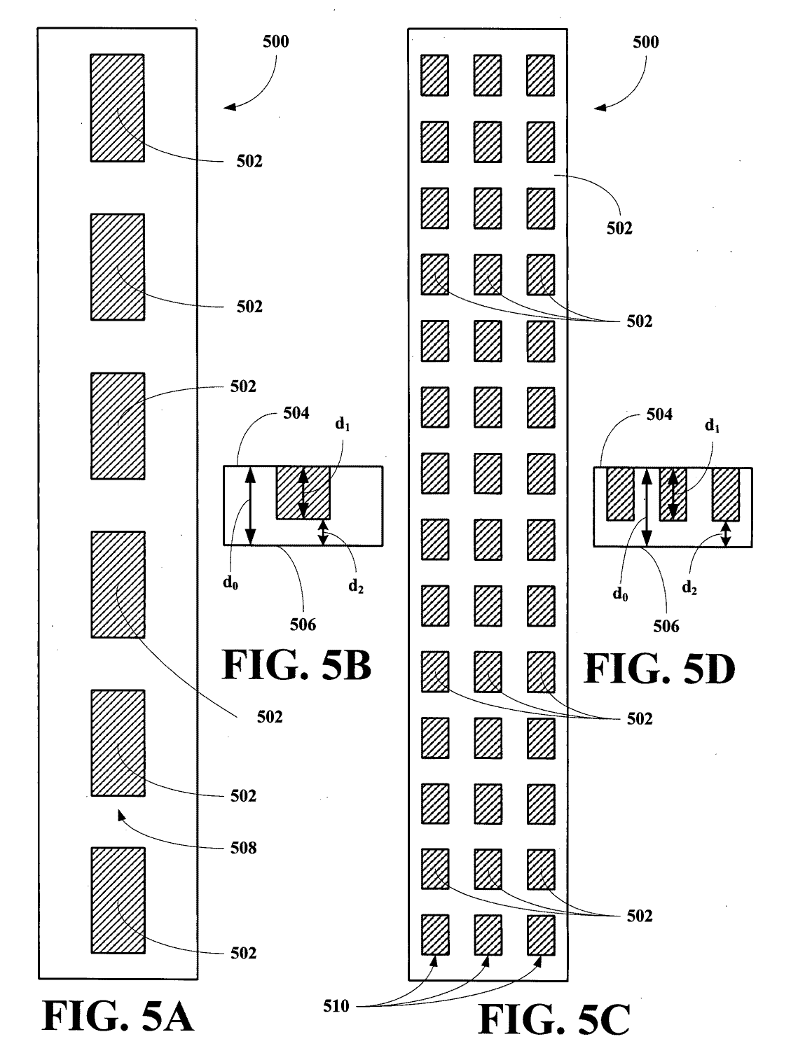

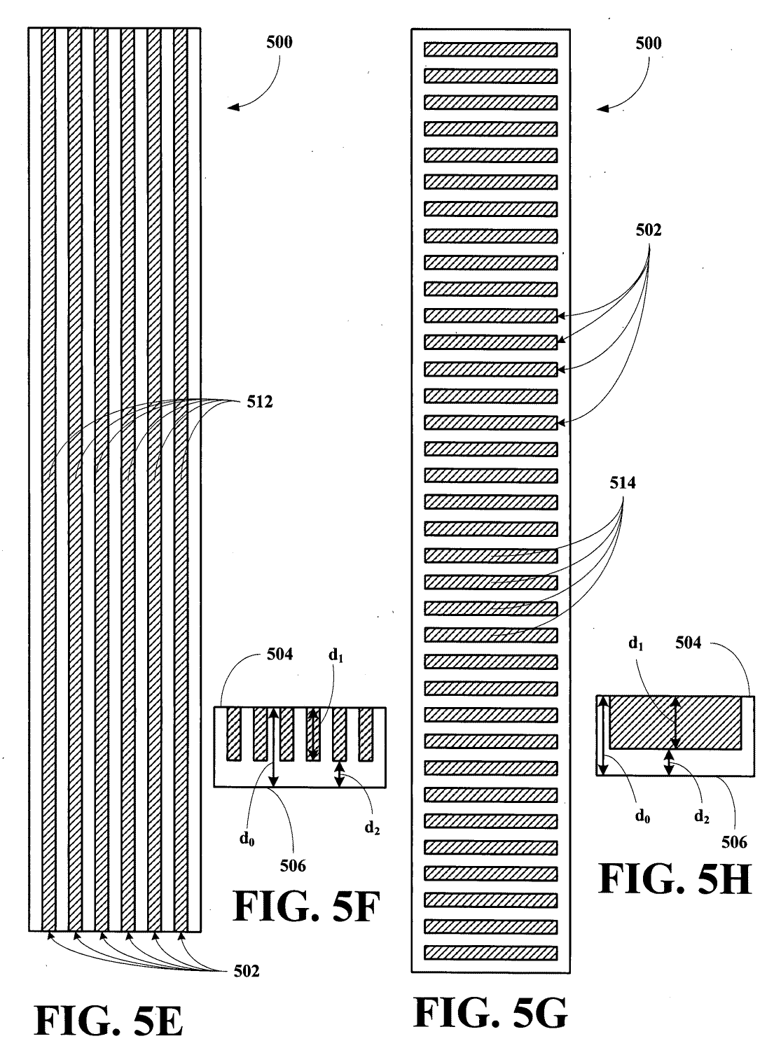

The apparatus 400 also includes a reagent station 406 including a reagent socket 408 adapted to receive a reagent cartridge 410, where the reagent socket 408 includes a reagent dispensing outlet or nozzle 412 adapted to allow one or a plurality of reagent from the reagent cartridge 410 to flow, to pump or to spray onto or into one zone or a plurality of zones 502 on the rigid substrate 500 (see FIGS. 5A-H). The outlet 412 is held proximate the top or zone side 504 of the rigid substrate 500 by a reagent station guide and socket holder 414.

After the reagent(s) has(have) been introduced onto or into the zone(s) 502, the rigid substrate 500 is advanced and passes through a single molecule or single molecular assemblage identifying or mapping station 416 including a light source 418 adapted to generate incident light beam 420 of a specific frequency range, a filter 422 adapted to narrow the frequency range of the incident light, and a lens 424 adapted to focus the light beam 418 onto the zone(s) 502 through a dove prism 426 having a long side 428 positioned proximate a back side 506 of the rigid substrate 500. It should be recognized by ordinary artisans that the light source can be designed without the filter 422 and/or the lens 424 depending on the type of light source used, e.g., a laser may not need the filter and/or lens, while a broad band light source would require the filter and lens. The incident light 420 impinges on the zone(s) 502 of the rigid substrate 500 where it excites fluorescent tags associated with, in proximity to or bonded to all reactive single molecule sites within the zone(s) 502. Fluorescent light emitted by active sites in the zone(s) 502 passes through an objective lens 430 held proximate the zone side 504 of the rigid substrate 500 by a detector 432, which detects an image of the fluorescent light emitted within a view field of the detector within the zone(s) 502. The detector 432 generates an output signal which is forwarded to an analyzer 434 via a cable 435a. The incident light beam 420 then passes out of the dove prism 426 into an absorption box 436 through a first light port 437a. The absorption box 436 is designed to absorb any incident light the is not absorbed to excited active sites in the zone(s) 502. The detector 432 and the analyzer 434 are adapted to detect and locate (identify) or map detectably discernible single molecule, single molecular or single molecular assemblage sites in the zone(s) 502.

After passing through the identification or mapping station 416, the rigid substrate 500 is advanced and passes through an initiation station 438 including an initiator socket 440 adapted to receive an initiator cartridge 442, where the initiator socket 440 includes an initiator dispensing outlet or nozzle 444 adapted to allow an initiator or a plurality of initiators from the initiator cartridge 442 to flow, pump, or spray onto or into a zone(s) 502 on the rigid substrate 500. The outlet 444 is held proximate the zone side 504 of the rigid substrate 500 by an initiation station holder 445.

Next, the rigid substrate 500 is advanced and passes through an event detection station 446 including a light source 448 adapted to generate incident light beam 450 of a specific frequency range, a filter 452 adapted to narrow the frequency range of the incident light, and a lens 454 adapted to focus the light beam 450 onto the zone(s) 502 through a dove prism 456 having a long side 458 positioned proximate a back side 506 of the rigid substrate 500. It should be recognized by ordinary artisans that the light source can be designed without the filter 452 and/or the lens 454 depending on the type of light source used, e.g., a laser may not need the filter and/or lens, while a broad band light source would require the filter and lens. The incident light 450 impinges on the zone(s) 502 of the rigid substrate 500 where it excites donor moieties associated with, in proximity to or bonded to all single molecule or single molecular sites within the zone(s) 502. The incident light 450 impinges on the zone(s) 502 of the film 500 where it excites fluorescent tags associated with, in proximity to or bonded to all reactive single molecule sites within the zone(s) 502. Fluorescent light emitted by active sites in the zone(s) 502 passes through an objective lens 460 held proximate the zone side 504 of the film 500 by a detector 462, which detects an image of the fluorescent light emitted within a view field of the detector within the zone(s) 502. The detector 432 generates an output signal which is forwarded to an analyzer 434 via a cable 435b. The incident light beam 420 then passes out of the dove prism 426 into an absorption box 464 through a second light port 437b. The absorption box 436 is designed to absorb any incident light the is not absorbed to excited active sites in the zone(s) 502. The detector 462 and the analyzer 434 are adapted to detect reaction events occurring at the detectably discernible single molecule, single molecular or single molecular assemblage sites previously identified or mapped in the zone(s) 502 within a given time period, the time the rigid substrate 500 takes to advance past the event detection station 446.

Referring now to FIG. 4B, another embodiment of an apparatus for monitoring single molecule or single molecular assemblage events of this invention, generally 400, is shown to include a guide slot 402 and a drive bar 404. The drive bar 404 is adapted to move a rigid substrate 500 through the slot 402 past each of a plurality of stations of the apparatus 400. The substrate 500 includes a top side 504 and a bottom side 506, where the top side 504 have zones formed or disposed therein or thereon.

The rigid substrate 500 advances to a buffer station 466 including a buffer socket 468 adapted to receive a buffer cartridge 470, where the buffer socket 468 includes a buffer dispensing outlet or nozzle 472 adapted to allow a buffer from the buffer cartridge 470 to flow, to be pumped or to be sprayed onto or into a zone(s) 502 on the rigid substrate 500 to equilibrate the zone(s) 502 with the buffer. The outlet 472 is held proximate the zone side 504 of the rigid substrate 500 by a buffer station rigid substrate guide and socket holder 474.

After the buffer station 466, the rigid substrate 500 is advanced to the sample station 406 including a sample socket 408 adapted to receive a sample cartridge 410, where the sample socket 408 includes a sample dispensing outlet or nozzle 412 adapted to allow a sample from the sample cartridge 410 to flow onto or into a zone or a plurality of zones 502 on the rigid substrate 500. The outlet 412 is held proximate the zone side 504 of the rigid substrate 500 by a sample station rigid substrate guide and socket holder 414.

After the sample has been introduced onto or into the zone(s) 502, the rigid substrate 500 is advanced and passes through a single molecule or single molecular assemblage identification or mapping station 416 including a light source 418 adapted to generate incident light beam 420 of a specific frequency range, a filter 422 adapted to narrow the frequency range of the incident light, and a lens 424 adapted to focus the light beam 418 onto the zone(s) 502 through a dove prism 426 having a long side 428 positioned proximate a back side 506 of the rigid substrate 500. It should be recognized by ordinary artisans that the light source can be designed without the filter 422 and/or the lens 424 depending on the type of light source used, e.g., a laser may not need the filter and/or lens, while a broad band light source would require the filter and lens. The incident light 420 impinges on the zone(s) 502 of the rigid 500 where it excites fluorescent tags associated with, in proximity to or bonded to all reactive single molecule sites within the zone(s) 502. Fluorescent light emitted by active sites in the zone(s) 502 passes through an objective lens 430 held proximate the zone side 504 of the film 500 by a detector 432, which detects an image of the fluorescent light emitted within a view field of the detector within the zone(s) 502. The detector 432 generates an output signal which is forwarded to an analyzer 434 via a cable 435a. The incident light beam 420 then passes out of the dove prism 426 into an absorption box 436 through a first light port 437a. The absorption box 436 is designed to absorb any incident light the is not absorbed to excited active sites in the zone(s) 502. The detector 432 and the analyzer 434 are adapted to detect and locate (identify) or map detectably discernible single molecule, single molecular or single molecular assemblage sites in the zone(s) 502.

After the passing through the identification or mapping station 416, the rigid substrate 500 is advanced and passes through an initiation station 438 including an initiator socket 440 adapted to receive an initiator cartridge 442, where the initiator socket 440 includes an initiator dispensing outlet or nozzle 444 adapted to allow an initiator from the initiator cartridge 442 to flow onto or into a zone(s) 502 on the rigid substrate 500. The outlet 444 is held proximate the zone side 504 of the rigid substrate 500 by an initiation station holder 445.

Next, the rigid substrate 500 is advanced and passes through an event detection station 446 including a light source 448 adapted to generate incident light beam 450 of a specific frequency range, a filter 452 adapted to narrow the frequency range of the incident light, and a lens 454 adapted to focus the light beam 450 onto the zone(s) 502 through a dove prism 456 having a long side 458 positioned proximate a back side 506 of the rigid substrate 500. It should be recognized by ordinary artisans that the light source can be designed without the filter 452 and/or the lens 454 depending on the type of light source used, e.g., a laser may not need the filter and/or lens, while a broad band light source would require the filter and lens. The incident light 450 impinges on the zone(s) 502 of the rigid substrate 500 where it excites donor moieties associated with, in proximity to or bonded to all single molecule or single molecular sites within the zone(s) 502. The incident light 450 impinges on the zone(s) 502 of the rigid substrate 500 where it excites fluorescent tags associated with, in proximity to or bonded to all reactive single molecule sites within the zone(s) 502. Fluorescent light emitted by active sites in the zone(s) 502 passes through an objective lens 460 held proximate the zone side 504 of the film 200 by a detector 462, which detects an image of the fluorescent light emitted within a view field of the detector within the zone(s) 202. The detector 432 generates an output signal which is forwarded to an analyzer 434 via a cable 435b. The incident light beam 420 then passes out of the dove prism 426 into an absorption box 436 through a second light port 437b. The absorption box 436 is designed to absorb any incident light the is not absorbed to excited active sites in the zone(s) 502. The detector 462 and the analyzer 434 are adapted to detect reaction events occurring at the detectably discernible single molecule, single molecular or single molecular assemblage sites previously identified or mapped in the zone(s) 502 within a given time period, the time the rigid substrate 500 takes to advance past the event detection station 446.

Referring now to FIG. 4C, another embodiment of an apparatus for monitoring single molecule or single molecular assemblage events of this invention, generally 400, is shown to include a guide slot 402 and a drive bar 404. The drive bar 404 is adapted to move a rigid substrate 500 through the slot 402 past each of a plurality of stations of the apparatus 400. The substrate 500 includes a top side 504 and a bottom side 506, where the top side 504 have zones formed or disposed therein or thereon.

The rigid substrate 500 advances to a buffer station 466 including a buffer socket 468 adapted to receive a buffer cartridge 470, where the buffer socket 468 includes a buffer dispensing outlet or nozzle 472 adapted to allow a buffer from the buffer cartridge 470 to flow onto or into a zone(s) 502 on the rigid substrate 500 to equilibrate the zone(s) 502 with the buffer. The outlet 472 is held proximate the zone side 504 of the rigid substrate 500 by a buffer station rigid substrate guide and socket holder 474.

After the buffer station 466, the rigid substrate 500 is advanced to the sample station 406 including a sample socket 408 adapted to receive a sample cartridge 410, where the sample socket 408 includes a sample dispensing outlet or nozzle 412 adapted to allow a sample from the sample cartridge 410 to flow onto or into a zone or a plurality of zones 502 on the rigid substrate 500. The outlet 412 is held proximate the zone side 504 of the rigid substrate 500 by a sample station rigid substrate guide and socket holder 414.

After the sample station 406, the rigid substrate 500 advances to a wash station 476 including a wash socket 478 adapted to receive a wash cartridge 480, where the wash socket 478 includes a buffer dispensing nozzle 482 adapted to allow a wash solution from the wash cartridge 480 to flow onto or into a zone or a plurality of zones on the rigid substrate 500 to remove or reduce unbound sample within the zone(s) 502. The outlet 482 is held proximate the zone side 504 of the rigid substrate 500 by a sample station rigid substrate guide and socket holder 484.

After the sample has been introduced onto or into the zone(s) 502 and washed, the rigid substrate 500 is advanced and passes through a single molecule or single molecular assemblage identification or mapping station 416 including a light source 418 adapted to generate incident light beam 420 of a specific frequency range, a filter 422 adapted to narrow the frequency range of the incident light, and a lens 424 adapted to focus the light beam 418 onto the zone(s) 502 through a dove prism 426 having a long side 428 positioned proximate a back side 506 of the rigid substrate 500. It should be recognized by ordinary artisans that the light source can be designed without the filter 422 and/or the lens 424 depending on the type of light source used, e.g., a laser may not need the filter and/or lens, while a broad band light source would require the filter and lens. The incident light 420 impinges on the zone(s) 502 of the rigid 500 where it excites fluorescent tags associated with, in proximity to or bonded to all reactive single molecule sites within the zone(s) 502. Fluorescent light emitted by active sites in the zone(s) 502 passes through an objective lens 430 held proximate the zone side 504 of the film 500 by a detector 432, which detects an image of the fluorescent light emitted within a view field of the detector within the zone(s) 502. The detector 432 generates an output signal which is forwarded to an analyzer 434 via a cable 435a. The incident light beam 420 then passes out of the dove prism 426 into an absorption box 436 through a first light port 437a. The absorption box 436 is designed to absorb any incident light the is not absorbed to excited active sites in the zone(s) 502. The detector 432 and the analyzer 434 are adapted to detect and locate (identify) or map detectably discernible single molecule, single molecular or single molecular assemblage sites in the zone(s) 502.

After the passing through the identification or mapping station 416, the rigid substrate 500 is advanced and passes through an initiation station 438 including an initiator socket 440 adapted to receive an initiator cartridge 442, where the initiator socket 440 includes an initiator dispensing outlet or nozzle 444 adapted to allow an initiator from the initiator cartridge 442 to flow onto or into a zone(s) 502 on the rigid substrate 500. The outlet 444 is held proximate the zone side 504 of the rigid substrate 500 by an initiation station holder 445.

Next, the rigid substrate 500 is advanced and passes through an event detection station 446 including a light source 448 adapted to generate incident light beam 450 of a specific frequency range, a filter 452 adapted to narrow the frequency range of the incident light, and a lens 454 adapted to focus the light beam 450 onto the zone(s) 502 through a dove prism 456 having a long side 458 positioned proximate a back side 506 of the rigid substrate 500. It should be recognized by ordinary artisans that the light source can be designed without the filter 452 and/or the lens 454 depending on the type of light source used, e.g., a laser may not need the filter and/or lens, while a broad band light source would require the filter and lens. The incident light 450 impinges on the zone(s) 502 of the rigid substrate 500 where it excites donor moieties associated with, in proximity to or bonded to all single molecule or single molecular sites within the zone(s) 502. The incident light 450 impinges on the zone(s) 502 of the rigid substrate 500 where it excites fluorescent tags associated with, in proximity to or bonded to all reactive single molecule sites within the zone(s) 502. Fluorescent light emitted by active sites in the zone(s) 502 passes through an objective lens 460 held proximate the zone side 504 of the film 200 by a detector 462, which detects an image of the fluorescent light emitted within a view field of the detector within the zone(s) 202. The detector 432 generates an output signal which is forwarded to an analyzer 434 via a cable 435b. The incident light beam 420 then passes out of the dove prism 426 into an absorption box 436 through a second light port 437b. The absorption box 436 is designed to absorb any incident light the is not absorbed to excited active sites in the zone(s) 502. The detector 462 and the analyzer 434 are adapted to detect reaction events occurring at the detectably discernible single molecule, single molecular or single molecular assemblage sites previously identified or mapped in the zone(s) 502 within a given time period, the time the rigid substrate 500 takes to advance past the event detection station 446.

Referring now to FIG. 4D, another embodiment of an apparatus for monitoring single molecule or single molecular assemblage events of this invention, generally 400, is shown to include a guide slot 402 and a drive bar 404. The drive bar 404 is adapted to move a rigid substrate 500 through the slot 402 past each of a plurality of stations of the apparatus 400. The substrate 500 includes a top side 504 and a bottom side 506, where the top side 504 have zones formed or disposed therein or thereon.

The rigid substrate 500 advances to a buffer station 466 including a buffer socket 468 adapted to receive a buffer cartridge 470, where the buffer socket 468 includes a buffer dispensing outlet or nozzle 472 adapted to allow a buffer from the buffer cartridge 470 to flow onto or into a zone(s) 502 on the rigid substrate 500 to equilibrate the zone(s) 502 with the buffer. The outlet 472 is held proximate the zone side 504 of the rigid substrate 500 by a buffer station rigid substrate guide and socket holder 474.

After the buffer station 446, the rigid substrate 500 is advanced to the sample station 406 including a sample socket 408 adapted to receive a sample cartridge 410, where the sample socket 408 includes a sample dispensing outlet or nozzle 412 adapted to allow a sample from the sample cartridge 410 to flow onto or into a zone or a plurality of zones 502 on the rigid substrate 500. The outlet 412 is held proximate the zone side 504 of the rigid substrate 500 by a sample station rigid substrate guide and socket holder 414.

The apparatus 400 also includes a reacting agent station 486 including a reacting agent socket 488 adapted to receive a reacting agent cartridge 490, where the reacting agent socket 488 includes a reacting agent dispensing nozzle 492 adapted to allow a reacting agent from the reacting agent cartridge 490 to flow onto or into a zone(s) 502 on the rigid substrate 500. The outlet 492 is held proximate the zone side 504 of the rigid substrate 500 by a reacting agent station rigid substrate guide and socket holder 494. It should be recognized by an ordinary artisan that the apparatus 400 can include additional sample stations and reacting agent stations and that their order (which comes first) is only dependent on the exact reaction to which the apparatus 400 is to be used. For example, in nucleic acid sequencing where the zones have bound therein a template or a primer, the sample would comprise a primer or a template (to form a bound duplex) and the reacting agent would comprise a polymerizing agent such as a polymerase or a transcriptase (naturally occurring or man-made).

After the reacting agent station 486, the rigid substrate 500 advances to a wash station 476 including a wash socket 478 adapted to receive a wash cartridge 480, where the wash socket 478 includes a buffer dispensing nozzle 482 adapted to allow a wash solution from the wash cartridge 480 to flow onto or into a zone or a plurality of zones on the rigid substrate 500 to remove or reduce unbound sample within the zone(s) 502. The outlet 482 is held proximate the zone side 504 of the rigid substrate 500 by a sample station rigid substrate guide and socket holder 484.

After the sample and reagents have been introduced onto or into the zone(s) 502 and washed, the rigid substrate 500 is advanced and passes through a single molecule or single molecular assemblage identification or mapping station 416 including a light source 418 adapted to generate incident light beam 420 of a specific frequency range, a filter 422 adapted to narrow the frequency range of the incident light, and a lens 424 adapted to focus the light beam 418 onto the zone(s) 502 through a dove prism 426 having a long side 428 positioned proximate a back side 506 of the rigid substrate 500. It should be recognized by ordinary artisans that the light source can be designed without the filter 422 and/or the lens 424 depending on the type of light source used, e.g., a laser may not need the filter and/or lens, while a broad band light source would require the filter and lens. The incident light 420 impinges on the zone(s) 502 of the rigid 500 where it excites fluorescent tags associated with, in proximity to or bonded to all reactive single molecule sites within the zone(s) 502. Fluorescent light emitted by active sites in the zone(s) 502 passes through an objective lens 430 held proximate the zone side 504 of the film 500 by a detector 432, which detects an image of the fluorescent light emitted within a view field of the detector within the zone(s) 502. The detector 432 generates an output signal which is forwarded to an analyzer 434 via a cable 435a. The incident light beam 420 then passes out of the dove prism 426 into an absorption box 436 through a first light port 437a. The absorption box 436 is designed to absorb any incident light the is not absorbed to excited active sites in the zone(s) 502. The detector 432 and the analyzer 434 are adapted to detect and locate (identify) or map detectably discernible single molecule, single molecular or single molecular assemblage sites in the zone(s) 502.

After the passing through the identification or mapping station 416, the rigid substrate 500 is advanced and passes through an initiation station 438 including an initiator socket 440 adapted to receive an initiator cartridge 442, where the initiator socket 440 includes an initiator dispensing outlet or nozzle 444 adapted to allow an initiator from the initiator cartridge 442 to flow onto or into a zone(s) 502 on the rigid substrate 500. The outlet 444 is held proximate the zone side 504 of the rigid substrate 500 by an initiation station holder 445.

Next, the rigid substrate 500 is advanced and passes through an event detection station 446 including a light source 448 adapted to generate incident light beam 450 of a specific frequency range, a filter 452 adapted to narrow the frequency range of the incident light, and a lens 454 adapted to focus the light beam 450 onto the zone(s) 502 through a dove prism 456 having a long side 458 positioned proximate a back side 506 of the rigid substrate 500. It should be recognized by ordinary artisans that the light source can be designed without the filter 452 and/or the lens 454 depending on the type of light source used, e.g., a laser may not need the filter and/or lens, while a broad band light source would require the filter and lens. The incident light 450 impinges on the zone(s) 502 of the rigid substrate 500 where it excites donor moieties associated with, in proximity to or bonded to all single molecule or single molecular sites within the zone(s) 502. The incident light 450 impinges on the zone(s) 502 of the rigid substrate 500 where it excites fluorescent tags associated with, in proximity to or bonded to all reactive single molecule sites within the zone(s) 502. Fluorescent light emitted by active sites in the zone(s) 502 passes through an objective lens 460 held proximate the zone side 504 of the film 200 by a detector 462, which detects an image of the fluorescent light emitted within a view field of the detector within the zone(s) 202. The detector 432 generates an output signal which is forwarded to an analyzer 434 via a cable 435b. The incident light beam 420 then passes out of the dove prism 426 into an absorption box 436 through a second light port 437b. The absorption box 436 is designed to absorb any incident light the is not absorbed to excited active sites in the zone(s) 502. The detector 462 and the analyzer 434 are adapted to detect reaction events occurring at the detectably discernible single molecule, single molecular or single molecular assemblage sites previously identified or mapped in the zone(s) 502 within a given time period, the time the rigid substrate 500 takes to advance past the event detection station 446.

It should be recognized by one skilled in the art that the number of stations can be increased or decreased depending on the specific application to which the apparatus is being used. But the apparatus of FIG. 4A is a minimal configuration for tape type embodiments of this invention.

### Rigid Substrate Configurations

Referring now to FIGS. 5A-H, several embodiments of rigid substrates of this invention, generally 494, are shown. Looking at FIGS. 5A-B, a rigid substrate 500 having a thickness d₀ and including a plurality of spaced apart zones 496 disposed on a zone side 498 and having a depth d₁, while maintaining a sufficient remaining rigid substrate thickness d₂ measured from a rigid substrate back side 500. The zones 502 of this embodiment are disposed in a middle 502 of the rigid substrate 500.

Looking at FIGS. 5C-D, a first rigid substrate 500 having a thickness d₀ and including three parallel disposed rows 504, each row 510 includes a plurality of spaced apart zones 502 disposed on a zone side 504 and having a depth d₁, while maintaining a sufficient remaining rigid substrate thickness d₂ measured from a rigid substrate back side 506. The zones 502 of this embodiment are disposed in a middle 508 of the rigid substrate 500. Although the zones are shown as rectangular, the shape is not meant as a limitation as the zones can be any shape including, without limitation, circular, elliptical, triangular, polygonal, or any other shape one would desire, being a design preference and not a limitation preference.

Looking at FIGS. 5E-F, a rigid substrate 500 having a thickness d₀ and including a plurality zones 502 comprising six parallel disposed, bands 506, each band 512 is disposed on a zone side 504 and having a depth d₁, while maintaining a sufficient remaining rigid substrate thickness d₂ measured from a rigid substrate back side 506. The zones 502 of this embodiment are disposed in a middle 508 of the rigid substrate 500.

Looking at FIGS. 5G-H, a rigid substrate 500 having a thickness d₀ and including a plurality zones 502 comprising six transversely disposed bands 508, each band 514 is disposed on a zone side 504 and having a depth d₁, while maintaining a sufficient remaining rigid substrate thickness d₂ measured from a rigid substrate back side 506. The zones 502 of this embodiment are disposed in a middle 508 of the rigid substrate 500.

Although four rigid substrate configuration have been described above, it should be clear to ordinary artisans that other zone configurations can be inscribed in the surface of a rigid substrate provided that the zones are capable of binding reagents within the zones and capable of passing through the stations of the apparatus so that buffers, samples, reacting agents and initiators can be added to the zones and so that light can be used to map detectably discernible reactive molecular sites and can be used to detect reaction events occurring in the mapped sites.d

### Disk Based Apparatus Embodiments

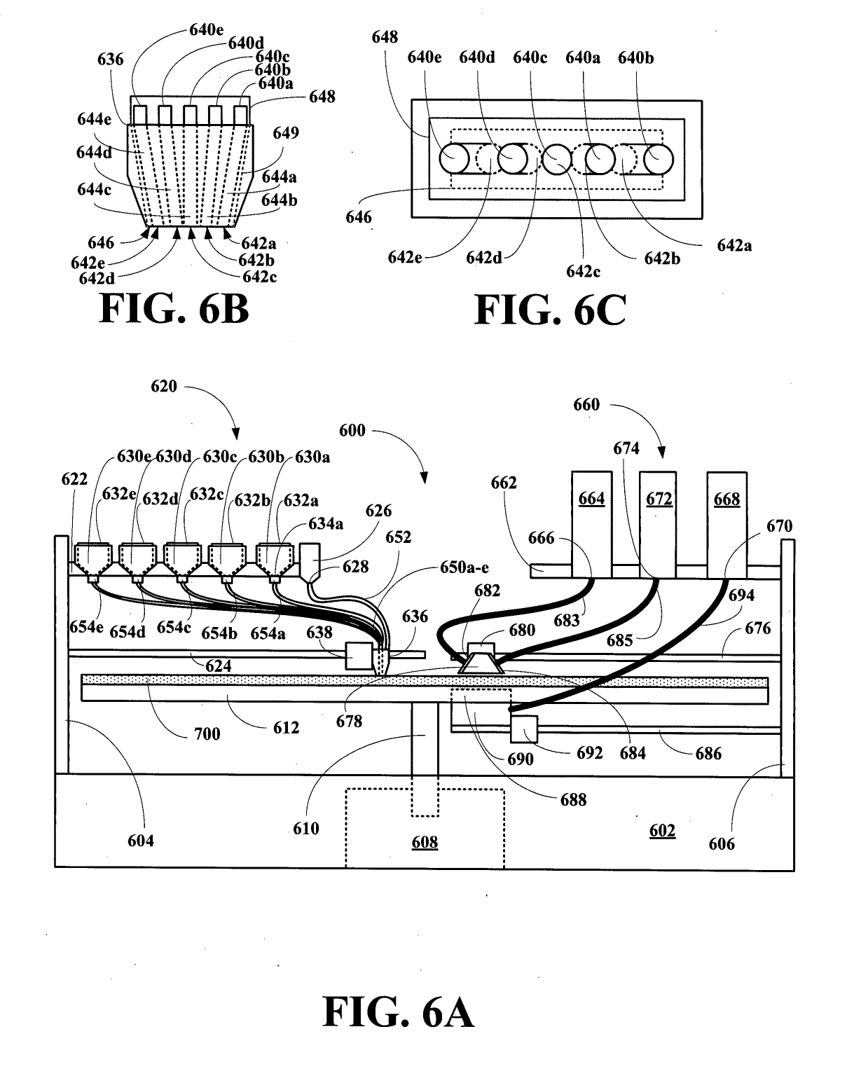

Referring now to FIGS. 6A-C, an embodiment of disk-type apparatus of this invention, generally 600, are shown to include a base unit 602, a reagent unit 620 and an irradiation/detection unit 660. The base unit 602 includes a reagent unit support 604, an irradiation/detection unit support 606, a motor 608 and a shaft 610 supporting a rotatable table 612, where the motor 608 is designed to turn the shaft 610 which in turn turns the rotatable table 612. The rotatable table 612 is designed to support a disk 700, described more fully herein, and includes a disk guide 614.

The reagent unit 620 includes an reagent arm 622 and a dispensing head arm 624. The reagent arm 622 supports a vacuum unit 626 having a vacuum inlet 628 and five reagent sockets 630a-e having inserted therein five reagent cartridges 632a-e and having reagent socket outlets 634a-f. The dispensing head arm 624 includes a dispensing head 636 and a dispensing head motor 638 designed to move the dispensing head 636 along the dispensing head arm 624, which allows the dispensing head 636 to be positioned to different positions on the disk 700 as the disk 700 is spun under the head 636. The head 636 includes five reagent inlets 640a-f, five reagent outlets 642a-f, five conduits 644a-f interconnecting the reagent inlets 640a-f and the reagent outlets 642a-f, a suction line inlet 646 and a suction outlet 648 interconnected via a suction conduit 649. The reagents inlets 640a-f are connected to the socket outlets 634a-f via reagent transfer tubes 650a-f; while the vacuum outlet 628 is connected to the suction line inlet 646 via a suction tube 652. The reagents cartridges 632a-f are designed to supply a reagent to a zone 702 on the disk 700 via the reagent tubes 650a-f and the suction outlet 644 is designed to remove excess reagent during and/or after reagent application to the zone 702. The sockets 630a-f can and generally do have pumps 654a-f associated with them so that the flow of reagents from the cartridges 632a-f can be controlled.

The irradiation/detection unit 660 includes a light source/absorber/analyzer support arm 662 supporting a light source 664 having a light outlet 666, an analyzer 668 and a light absorber 672 having a light inlet 674. The irradiation/detection unit 660 also includes a prism arm 676 supporting a dove prism 678 and a motor 680 adapted to move the prism 678 along the prism arm 676 so that the prism 678 can be positioned relative to a zone 702 on the disk 700 as the disk 700 spins under the prism 678. The prism 678 includes a light input member 682 and a light output member 684. The light input member 682 is connected to the light source outlet 666 by an optical conduit 683; while the light output member 684 is connected to the absorber inlet 674 by a second optical conduit 685. The irradiation/detection unit 660 also include a detector arm 686 supporting an objective lens 688, a detector 690 and a motor 692 adapted to move the objective lens 688 and the detector 690 along the detector arm 686 so that the objective lens 688 and the detector 690 can be positioned relative to the zone 702 on the disk 700 as the disk spins above the objective lens 688. The movement of the objective lens 688 and the detector 690 and the prism 678 are synchronized so that the prism 678 and objective lens 688 sandwich the zone 702 therebetween making irradiation and detection possible. The detector 690 includes a cable 694 connecting the detector 690 and the analyzer 668.

### Disk Configurations

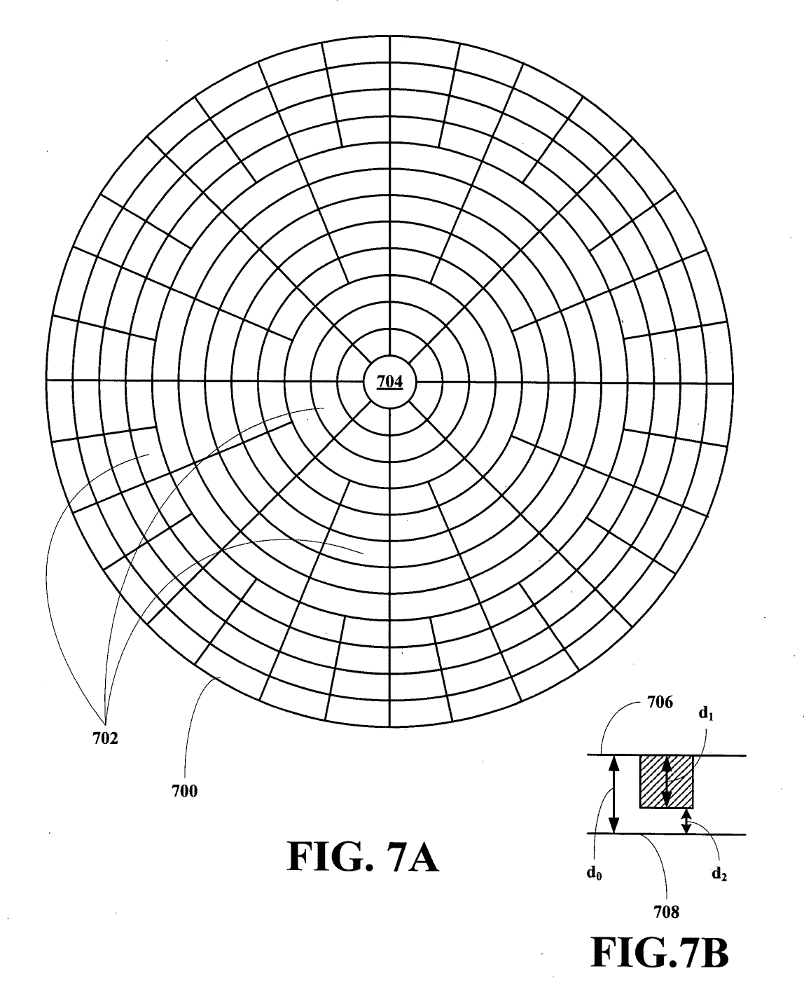

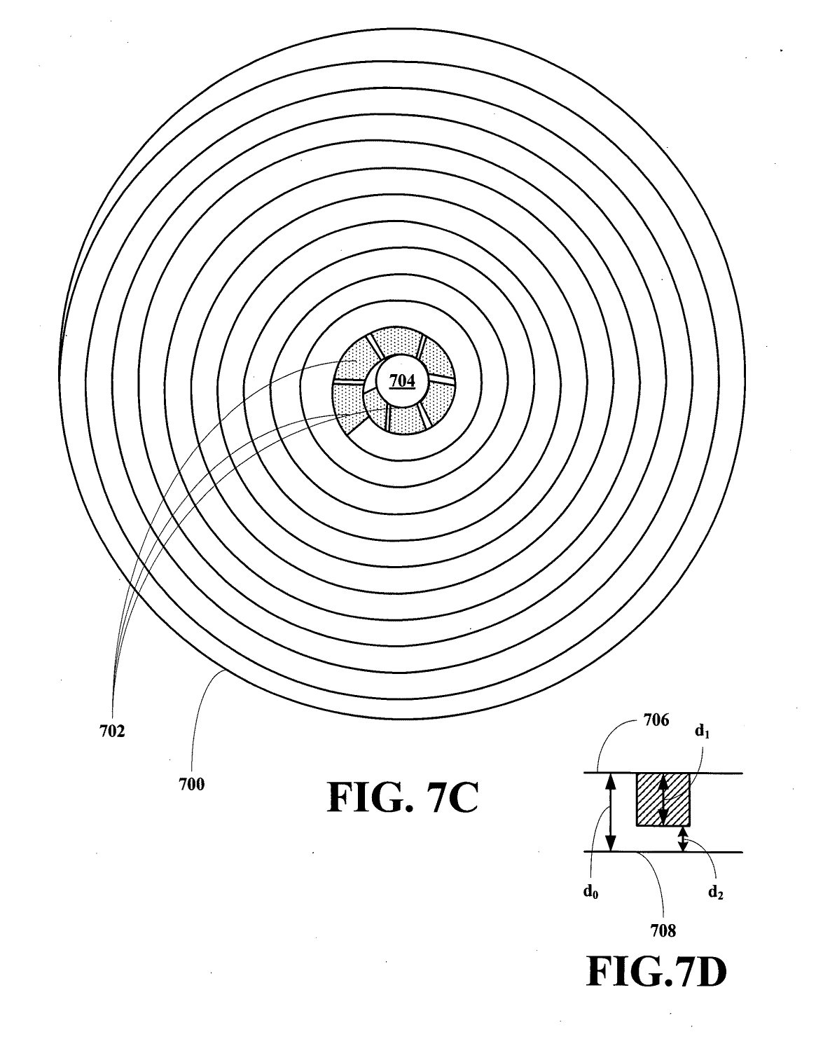

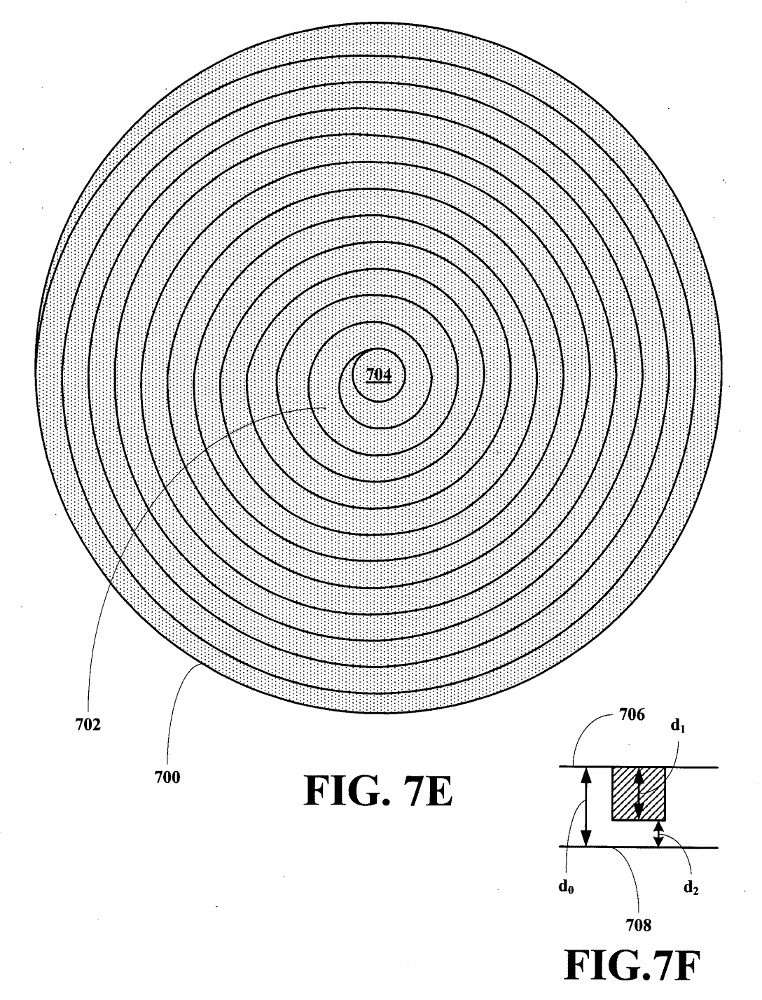

Referring now to FIGS. 7A&B, an embodiment of a disk of this invention, generally 700, to include a plurality of zones 702 and a central aperture 704 adapted to be fitted over the disk guide 614 so that the disk 700 can be properly positioned on the rotatable disk table 612. The zones 702 are set along sectors and subsectors of the disk 700. As shown in FIG. 7B, the zones 702 comprise areas of bound reagents that permit the isolation and localization of molecular complexes or assemblages so that single complex or assemblage identification and detection can be performed. The disk 700 have a thickness d₀ and the zones 702 extend from a top surface 706 to a depth of d₁ leaving a thickness d₂ of the disk 700 above a bottom surface 708 for support and confinement of the zones 702.

Referring now to FIGS. 7C&D, another embodiment of a disk of this invention, generally 700, to include a plurality of zones 702 and a central aperture 704 adapted to be fitted over the disk guide 614 so that the disk 700 can be properly positioned on the rotatable disk table 612. The zones 702 comprise divisions made in a spiral partitioning of the disk 700. The zones 702 comprise areas of bound reagents that permit the isolation and localization of molecular complexes or assemblages so that single complex or assemblage identification and detection can be performed. As shown in FIG. 7D, the zones 702 comprise areas of bound reagents that permit the isolation and localization of molecular complexes or assemblages so that single complex or assemblage identification and detection can be performed. The disk 700 have a thickness d₀ and the zones 702 extend from a top surface 706 to a depth of d₁ leaving a thickness d₂ of the disk 700 above a bottom surface 708 for support and confinement of the zones 702.

### Experiments of the Invention

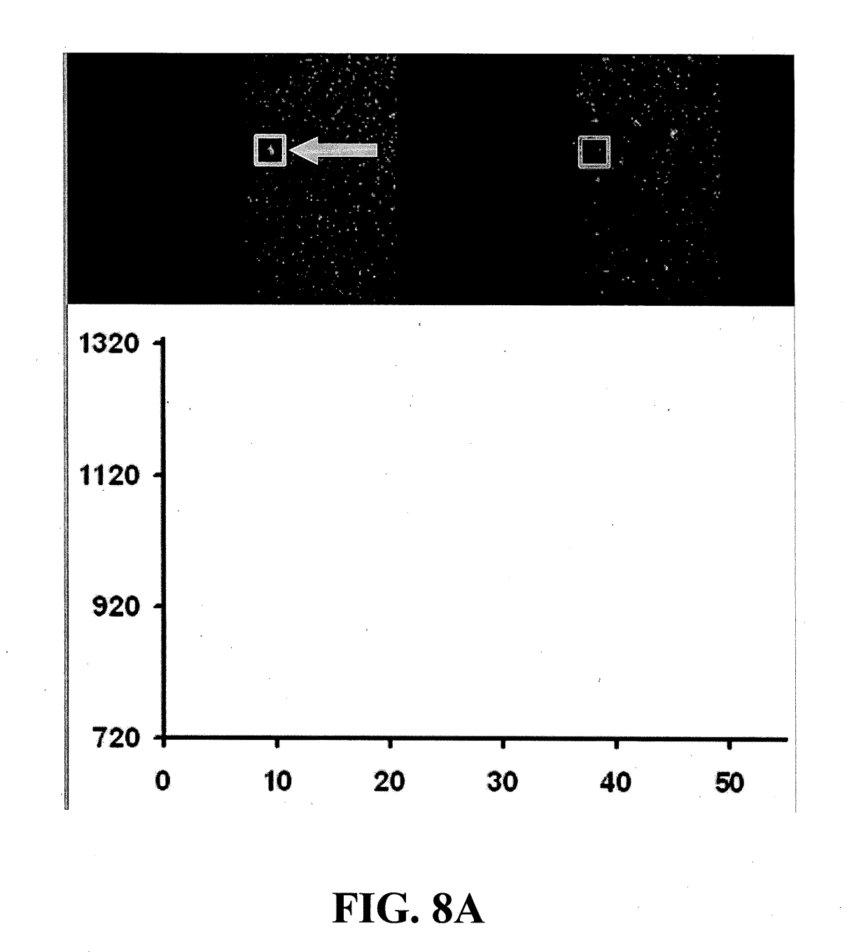

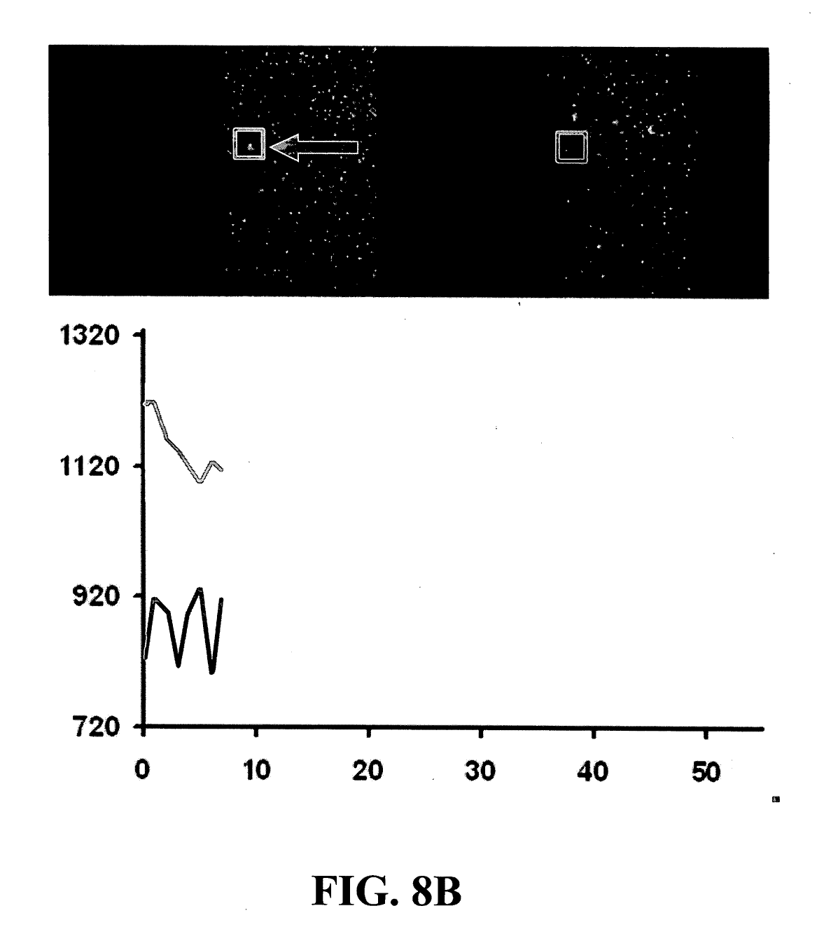

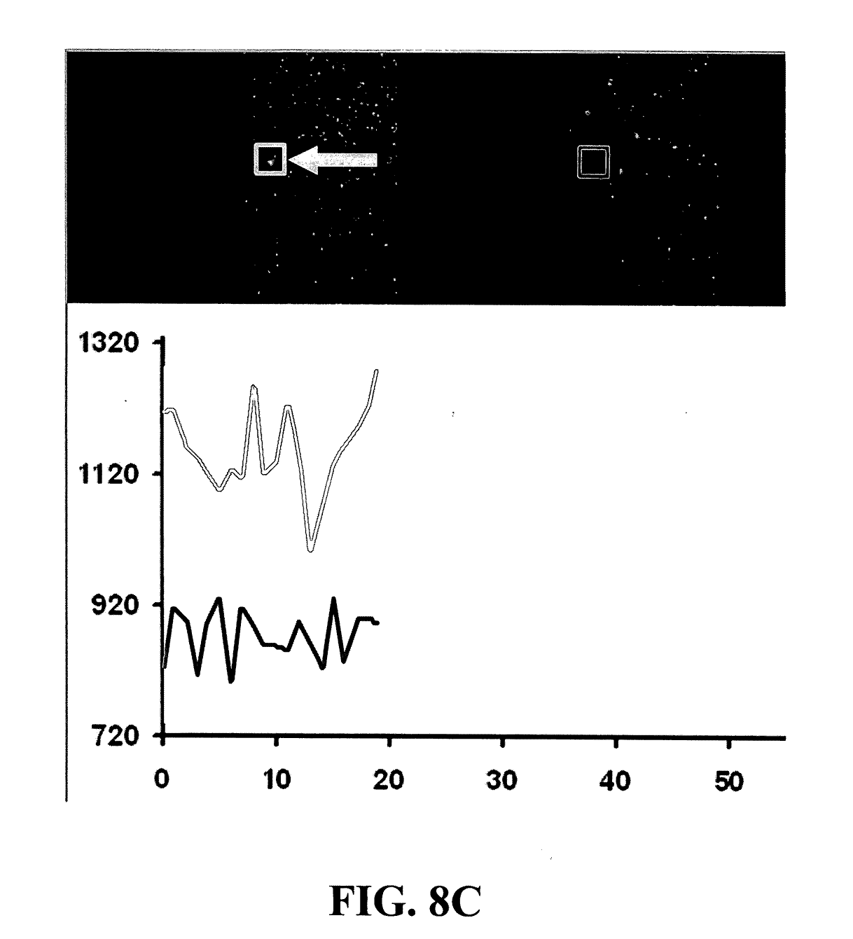

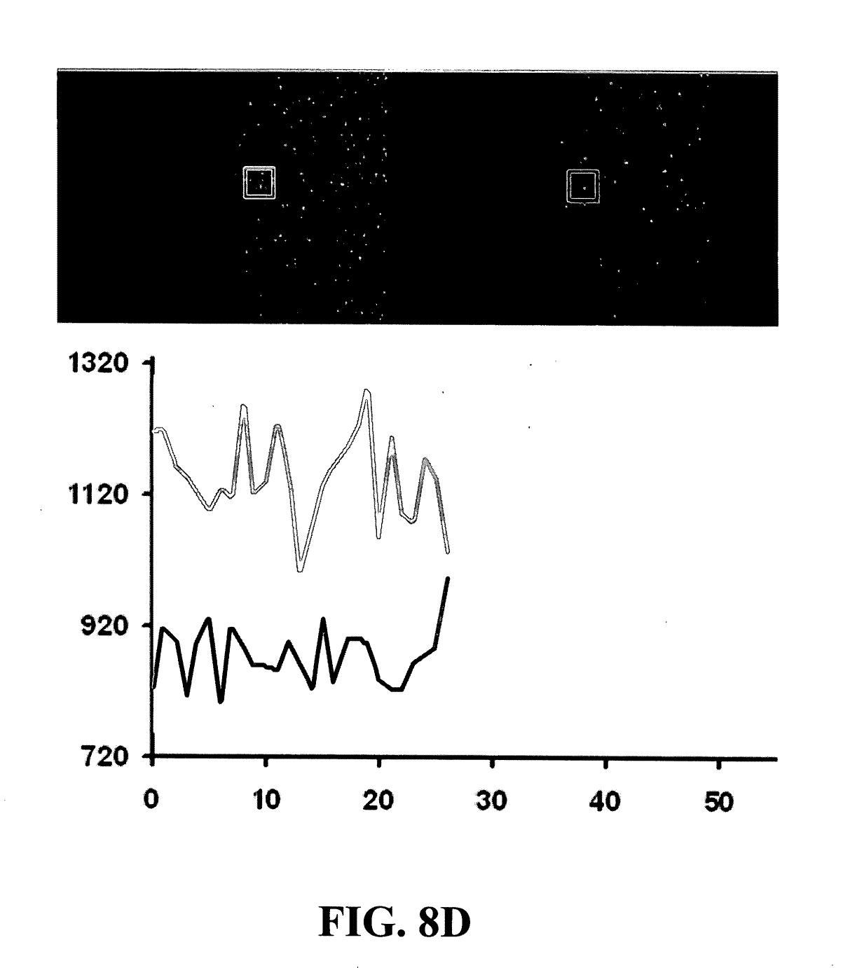

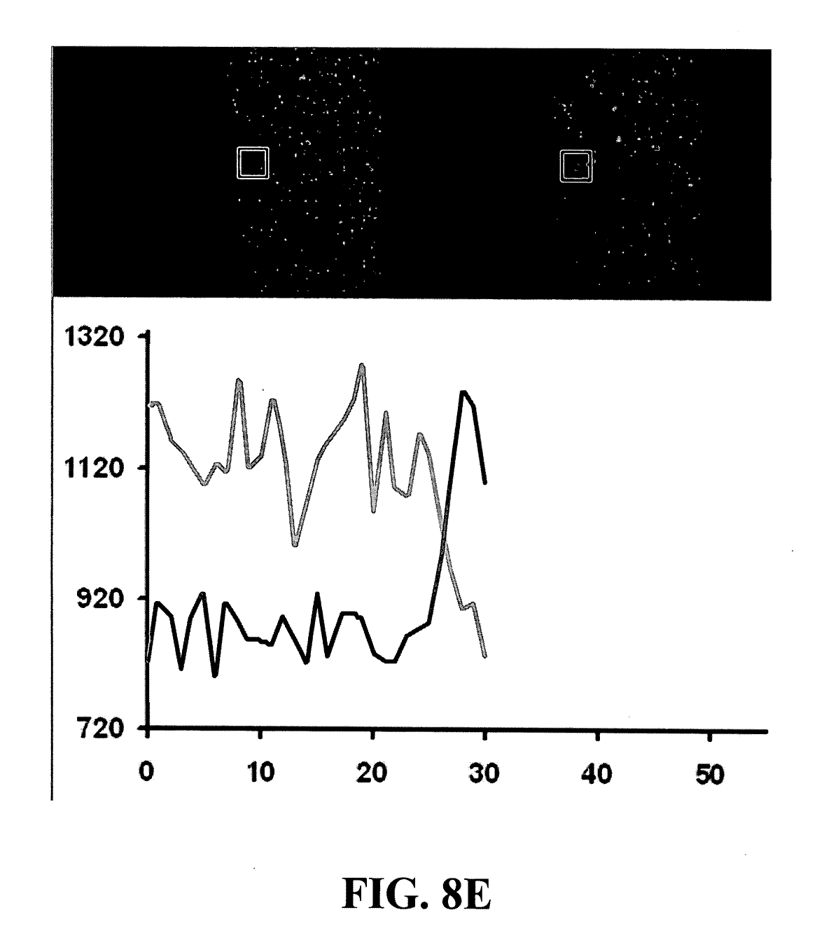

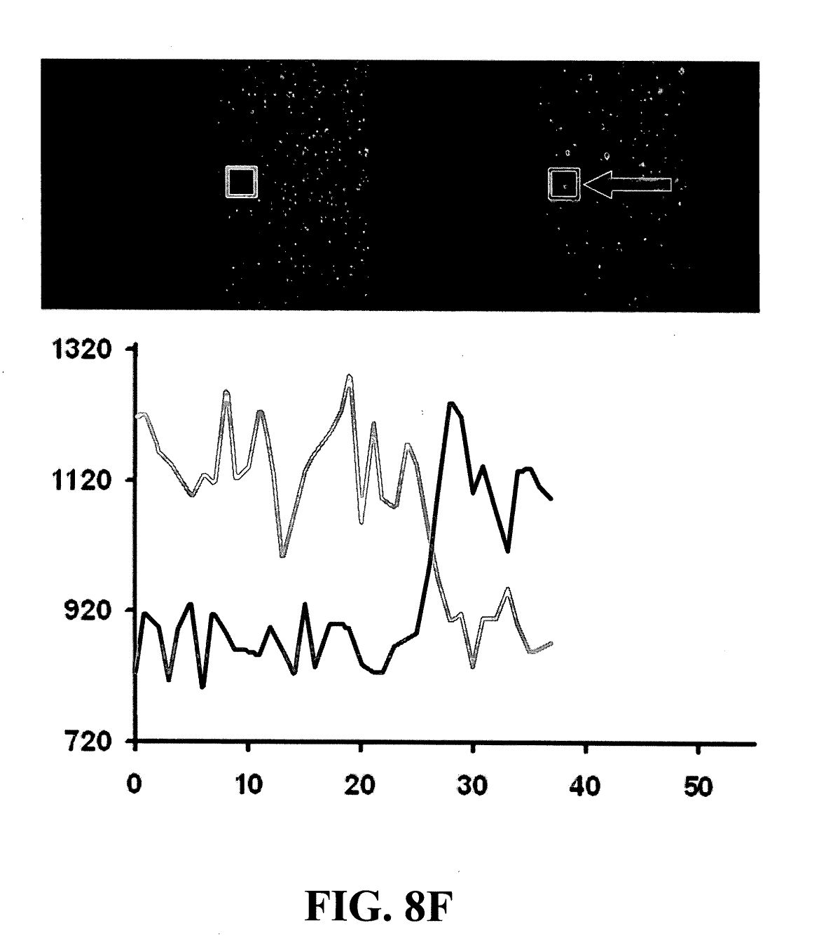

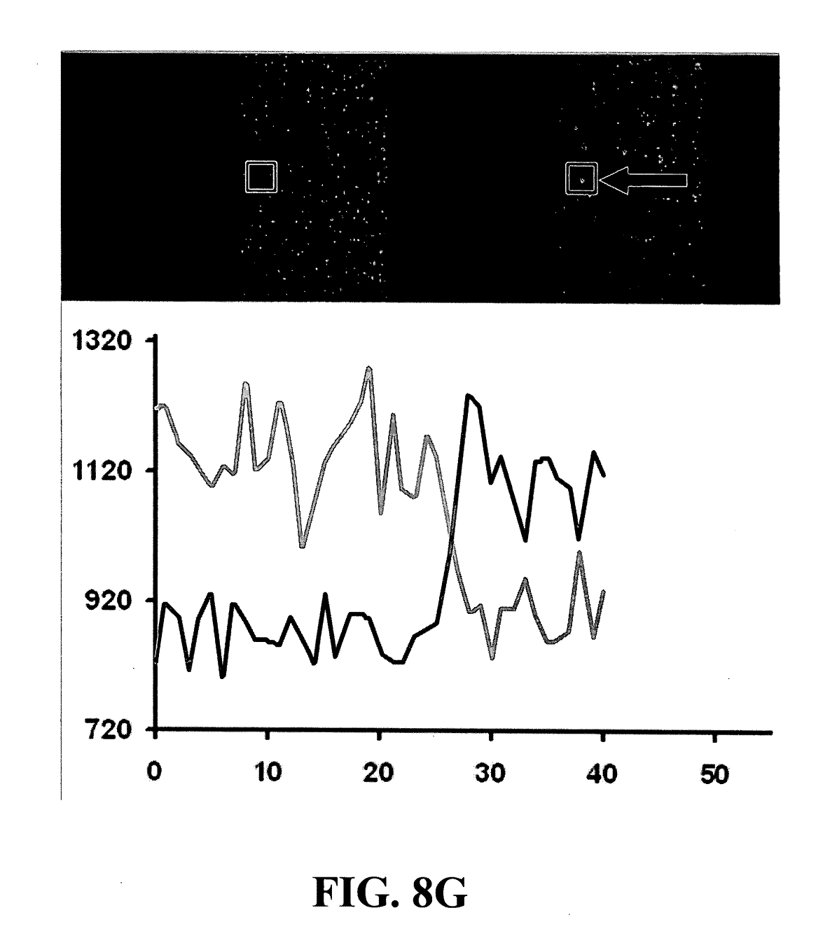

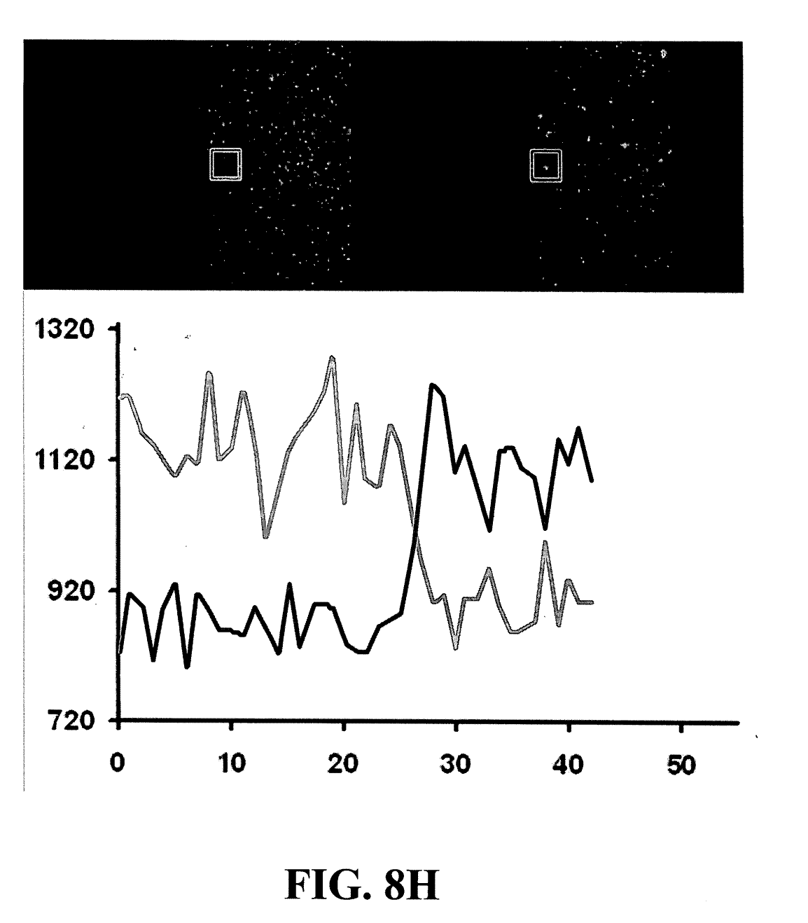

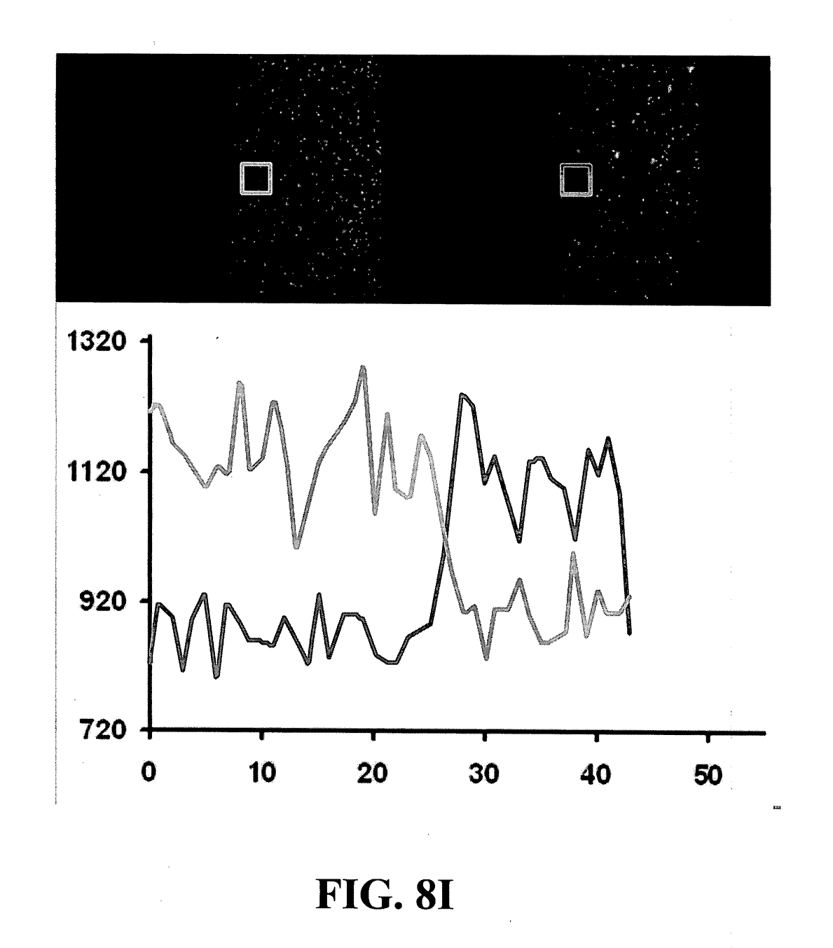

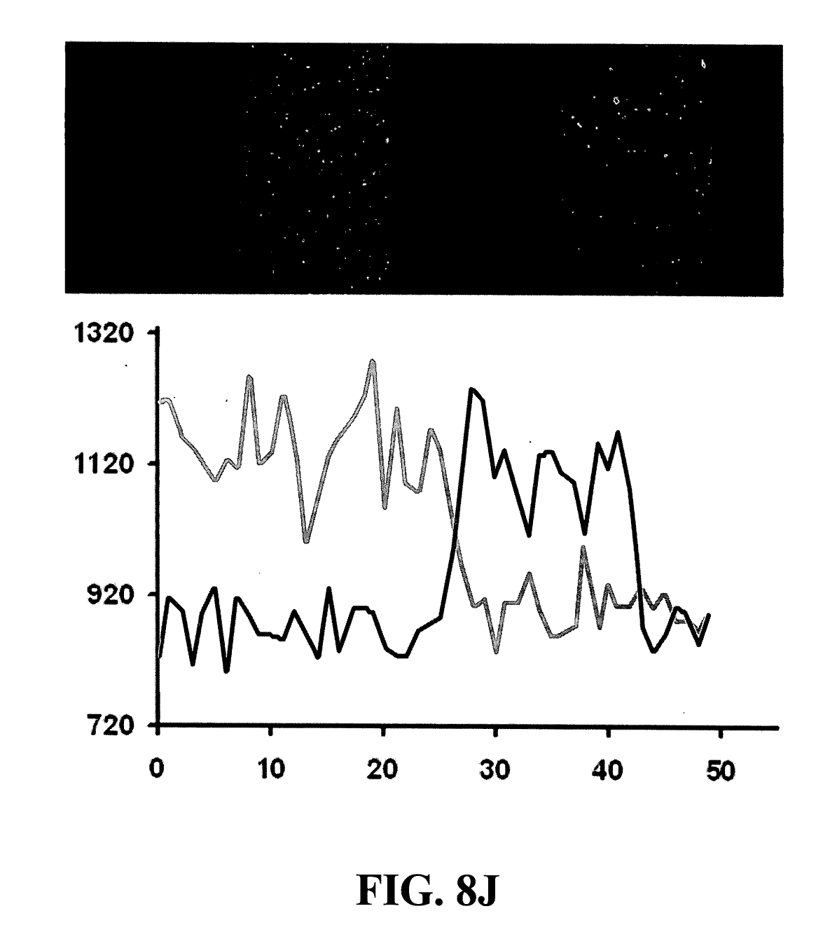

Referring now to FIGS. 8A-J, a series of camera frame images are shown the evidence detection while moving of another embodiment of a system of this invention. The images are coupled to plots showing the detected response of an acceptor channel and a donor channel, where the FRET interaction is evidence by the anti-correlated emission intensity from the two channels. Thus, as the donor intensity drops, the acceptor intensity rises evidencing a FRET event between the donor and acceptor. The moving frame images illustrate how the molecular sites propagate in the field of view (move along a controlled trajectory), which provides a mechanism of improved site recognition, signal detection, and signal analysis.

### Surface Preparation

A previously published method is used with minor modifications for the preparation of modified cover glass (Braslaysky et al., 2003).

Briefly, glass cover slips (0.16-0.19 mm thickness) are put 0/N in a base bath are then cleaned with 2% Micro-90 for 60 minutes with sonication and heat, followed by boiling RCA treatment for 60 minutes [2×30 mins]. The cleaned glass cover slips are then immersed in 2 mg/mL polyallylamine for 10 minutes and rinsed five times in water followed by an immersion in 2 mg/mL polyacrylic acid for 10 minutes and rinsed five times in water. This coating procedure is repeated again before the slides are coated with a 5 mM EDC-Biotin amine solution in 10 mM MES buffer, pH 5.5 for 30 minutes. After rinsing the slides in MES buffer for 5 minutes, in water for 5 minutes and in Trisb for 5 minutes, the final coat of 1 mg/mL Streptavidin is added by incubating for 30 minutes.

### Duplex Formation and Immobilization

The duplex to be immobilized is formed in solution prior to immobilization. The donor labeled template strand (Alexa Biotin Bot, 1 M) and acceptor labeled primer strand (Cy5 Top, 1 M) were mixed in 1× Klenow buffer, heated at 97° C. for 5 minutes, and allowed to cool to room temperature slowly over a period of one hour. The sample was diluted in 1× Klenow3 buffer to 100 pM, and immobilized on the PE surface at room temperature for 10 minutes. After immobilization, the excess sample was discarded and the cover glass was washed for 5 minutes in Trisb at room temperature, and mounted with 1× klenow buffer and observed under the microscope. The samples were excited using an argon laser and energy transfer between the donor and acceptor were detected via single pair FRET analysis. The distance between the donor and acceptor are ˜30 Å.

All references cited herein are incorporated by reference. Although the invention has been disclosed with reference to its embodiments, from reading this description those of skill in the art may appreciate changes and modification that may be made which do not depart from the scope and spirit of the invention as described above and claimed hereafter.

1.-26. (canceled)

25. A method for analyzing one reaction site, a small ensemble of reaction sites, a medium ensemble of reaction sites and a large ensemble of reaction sites comprising the step of:
providing a continuous substrate including a zone, where the zone includes one or a plurality of sparsely distributed binding sites;
passing the continuous substrate through one or a plurality of component introduction stations adapted to introduction the components required to immobilize and produce active sites in the zones, each site including at least one detectable agent having a detectable property, where the agents and the properties are the same or different;
passing the continuous substrate including active sites through a detection system, where reactions and/or interactions occurring at the sites within a viewing field are detected in a detector of the detection system to produce detected event signals, and
analyzing the detected event signals to convert the signals into data about the detected events.

26. A method for analyzing one reaction site, a small ensemble of reaction sites, a medium ensemble of reaction sites and a large ensemble of reaction sites comprising the step of:
providing a continuous substrate including a zone, where the zone includes one or a plurality of sparsely distributed binding sites;
passing the continuous substrate through one or a plurality of component introduction stations adapted to introduce components required to immobilize and produce pre-active sites in the zones, each site including at least one detectable agent having a detectable property, where the agents and the properties are the same or different;
passing the continuous substrate including the pre-active sites through a mapping station, where the pre-active sites are mapped relative to a grid associated with a viewing field of the mapping detector,
passing the continuous substrate including the pre-active sites through an initiation station, where one or a plurality of initiators are introduced into or onto the zones to convert some or all of the pre-active sites into active sites within the zones;
passing the continuous substrate including the active sites through a detection system, where reactions and/or interactions occurring at the sites within a viewing field are detected in a detector of the detection system to produce detected event signals, and
analyzing the mapped and detected event signals to convert the signals into data about the detected events.
